(19) United States
(12) Patent Application Publication
(10) Pub. No.: US 2023/0085486 A1
(43) Pub. Date: Mar. 16, 2023

(54) REMOVING DATA CONTRIBUTION FROM AGGREGATED AND/OR INTEGRATED GEOGRAPHIC DATABASE

(71) Applicant: HERE Global B.V., Eindhoven (NL)

(72) Inventors: Pavel Ivanov, Tampere (FI); Henri Jaakko Julius Nurminen, Tampere (FI); Marko Luomi, Lempaala (FI); Lauri Aarne Johannes Wirola, Tampere (FI)

(21) Appl. No.: 17/473,318

(22) Filed: Sep. 13, 2021

(51) Int. Cl. G01C 21/00

(52) U.S. Cl. CPC G01C 21/3807

(57) ABSTRACT

After the aggregation/integration of an instance of contributed data into an instance of map data, a processor detects a reversion trigger corresponding to the instance of contributed data. The processor obtains a copy of the instance of contributed data and determines an instance of reverted map data based on at least the copy of the instance of contributed data and the at least one instance of map data. The instance of reverted map data comprises values corresponding to a de-aggregation of the instance of contributed data from the instance of map data. The instance of reverted map data is stored and/or provided as part of a digital map.

### TECHNOLOGICAL FIELD

An example embodiment relates to maintaining or modifying a geographic database that is updated by aggregating instances of data. An example embodiment relates to removing instances of data that were aggregated and/or integrated into the geographic database.

### BACKGROUND

In various scenarios, positioning maps and/or other geographic databases may be generated and/or updated based on crowd-sourced data. For example, a user or group of users may contribute an instance of contributed data or a group of instances of contributed data. The instance(s) of contributed data may then be aggregated and/or integrated with respective instances of map data of the positioning map and/or other geographic database. In various instances, it may be determined that there is a potential problem with the accuracy of the instance of contributed data or the group of contributed data. Therefore, a problem exists as to how to mitigate or otherwise overcome negative effects of the potentially inaccurate instance of contributed data on the map data that is generated and/or updated by aggregating instances of contributed data.

### BRIEF SUMMARY

Various embodiments provide methods, apparatus, systems, and computer program products for mitigating the effects of potentially inaccurate instances of contributed data on map data generated by aggregating instances of contributed data. For example, various embodiments provide methods, apparatus, systems, and computer program products for removing instances of contributed data that were aggregated and/or integrated with other instances of contributed data and/or existing instances of map data to generate and/or update instances of map data of a digital map (e.g., in the form of a geographic database). For example, in an example embodiment, an instance of contributed data and/or a group of instances of contributed data are received and aggregated and/or integrated with respective other instances of contributed data and/or respective instances of existing map data to generate and/or update respective instances of map data. In various embodiments, respective counters associated with the instances of map data are generated and/or incremented, a hash of the instance of contributed data and/or group of instances of contributed data is generated and stored to a hash registry, and/or the like.

In an example embodiment, reversion trigger corresponding to an instance of contributed data or a group of instances of contributed data is received, thereby indicating that the instance of contributed data or the group of instances of contributed data are potentially inaccurate and/or are otherwise being recalled. In various embodiments, a copy of the instance of contributed data and/or group of instances of contributed data are obtained. For example, the reversion trigger may include a copy of the instance of contributed data and/or group of instances of contributed data, a pointer, instance or group identifier, and/or index that may be used to access and/or request a copy of the instance of contributed data and/or group of instances of contributed data, and/or the like. One or more respective instances of map data are identified corresponding to the instance of contributed data and/or the group of instances of contributed data being recalled. Based on the copy of the respective instance of contributed data and the respective instance of map data, a respective instance of reverted map data is generated by de-aggregating the respective instance of contributed data from the respective instance of map data. The respective instance of reverted map data is stored and/or provided, for example, for use in performing a positioning and/or navigation-related function. In an example embodiment, the hash corresponding to the instance of contributed data and/or group of instances of contributed data is deleted and/or flagged to indicate that the corresponding instance(s) of contributed data have been de-aggregated and/or de-integrated from the geographic database. In an example embodiment, the copy of the instance of contributed data and/or group of instances of contributed data is caused to be deleted and/or flagged to indicate that the corresponding instance(s) of contributed data have been de-aggregated and/or de-integrated from the geographic database.

In an example embodiment, a processor, after at least one instance of map data of a digital map has been generated or updated by aggregating at least a portion of an instance of contributed data with at least portions of one or more other instances of contributed data, detects a reversion trigger corresponding to the instance of contributed data. The processor obtains a copy of the instance of contributed data; and determines at least one instance of reverted map data based on at least a portion of the copy of the instance of contributed data and the at least one instance of map data. The at least one instance of reverted map data comprises values corresponding to a de-aggregation of the instance of contributed data from the at least one instance of map data. The processor causes at least one of storing or providing the at least one instance of reverted map data as part of the digital map.

In one aspect of the present disclosure, a method for de-aggregating or de-integrating potentially inaccurate contributed data from a geographic database is provided. In an example embodiment, the method is performed by a network device. In an example embodiment, the method comprises, after at least one instance of map data of a digital map has been generated or updated by aggregating at least a portion of an instance of contributed data with at least portions of one or more other instances of contributed data, detecting a reversion trigger corresponding to the instance of contributed data. The method further comprises obtaining a copy of the instance of contributed data; and determining at least one instance of reverted map data based on at least a portion of the copy of the instance of contributed data and the at least one instance of map data. The at least one instance of reverted map data comprises values corresponding to a de-aggregation of the instance of contributed data from the at least one instance of map data. The method further comprises at least one of storing or providing the at least one instance of reverted map data as part of the digital map.

In an example embodiment, the at least one instance of map data is associated with an instance counter indicating the number of instances of contributed data that have been aggregated to generate the at least one instance of map data and generating the at least one instance of reverted map data comprises decrementing the instance counter associated with the at least one instance of map data to determine a value of the instance counter associated with the at least one instance of reverted map data.

In an example embodiment, de-aggregation of the instance of contributed data from the at least one instance of map data comprises determining a value sum based on the instance of map data and the instance counter associated with the instance of map data, subtracting an observation value of the instance of contributed data from the value sum to generate a reverted value sum, and determining a reverted value for the at least one instance of reverted map data based on the reverted value sum and the instance counter associated with the at least one instance of reverted map data.

In an example embodiment, the digital map is configured for use in performing one or more positioning and/or navigation-related functions.

In an example embodiment, the copy of the instance of contributed data is stored by a computing entity (e.g., collecting device and/or third-party device) associated with an entity that contributed the instance of contributed data.

In an example embodiment, the method further comprises causing the copy of the instance of contributed data stored by the computing entity to be at least one of (a) deleted from memory of the computing entity or (b) flagged as having been de-aggregated from the digital map.

In an example embodiment, the reversion trigger indicates that a potential inaccuracy of the at least one instance of contributed data has been detected.

In an example embodiment, the reversion trigger is detected by a computing entity associated with an entity that contributed the instance of contributed data responsive to at least one of (a) receiving user input initiating the reversion trigger or (b) a reversion trigger initiation generated by an application operating on the computing entity.

In an example embodiment, the reversion trigger is identified responsive to determining that a quality index corresponding to the instance of map data indicates that the instance of map data is of lower quality after the instance of map data was updated based on the instance of contributed data than before the instance of map data was updated based on the instance of contributed data.

In an example embodiment, updating the at least one instance of map data based on the instance of contributed data comprises generating and storing a hash of the instance of contributed data in a hash registry, the method further comprising at least one of (a) deleting the hash of the instance of contributed data from the hash registry or (b) flagging the hash of the instance of contributed data in the hash registry to indicate that the instance of contributed data has been de-aggregated from the digital map.

In an example embodiment, the at least one instance of contributed data is part of a group of instances of contributed data comprising a plurality of instances of contributed data, obtaining a copy of the at least one instance of contributed data comprises obtaining a copy of each of respective instance of contributed data of the plurality of instances of contributed data, determining at least one instance of reverted map data comprises determining one or more instances of reverted map data corresponding to respective ones of the plurality of instances of contributed data.

In an example embodiment, updating the at least one instance of map data based on the plurality of instances of contributed data comprises generating and storing a hash of the plurality of instances of contributed data in a hash registry, the method further comprising at least one of (a) deleting the hash of the plurality of instances of contributed data from the hash registry or (b) flagging the hash of the plurality of instances of contributed data in the hash registry to indicate that respective instances of contributed data of the plurality of instances of contributed data have been de-aggregated from the digital map.

In an example embodiment, the instance of contributed data comprises an instance of radio observation data comprising information characterizing an observation of a radio node by a collecting device and an instance of location data indicating the location of the collecting device when the radio node was observed.

In an example embodiment, the information characterizing the observation of the radio node by the collecting device comprises at least one of (a) a radio node identifier, (b) an observed signal strength, or (c) an observed time parameter.

According to another aspect of the present disclosure, an apparatus (e.g., a network device) is provided. In an example embodiment, the apparatus comprises at least one processor and at least one memory storing computer program code and/or instructions. The at least one memory and the computer program code and/or instructions are configured to, with the processor, cause the apparatus to at least, after at least one instance of map data of a digital map has been generated or updated by aggregating at least a portion of an instance of contributed data with at least portions of one or more other instances of contributed data, detect a reversion trigger corresponding to the instance of contributed data. The at least one memory and the computer program code and/or instructions are further configured to, with the processor, cause the apparatus to at least obtain a copy of the instance of contributed data; and determine at least one instance of reverted map data based on at least a portion of the copy of the instance of contributed data and the at least one instance of map data. The at least one instance of reverted map data comprises values corresponding to a de-aggregation of the instance of contributed data from the at least one instance of map data. The at least one memory and the computer program code and/or instructions are further configured to, with the processor, cause the apparatus to at least store and/or provide the at least one instance of reverted map data as part of the digital map.

In an example embodiment, the at least one instance of map data is associated with an instance counter indicating the number of instances of contributed data that have been aggregated to generate the at least one instance of map data and generating the at least one instance of reverted map data comprises decrementing the instance counter associated with the at least one instance of map data to determine a value of the instance counter associated with the at least one instance of reverted map data.

In an example embodiment, de-aggregation of the instance of contributed data from the at least one instance of map data comprises determining a value sum based on the instance of map data and the instance counter associated with the instance of map data, subtracting an observation value of the instance of contributed data from the value sum to generate a reverted value sum, and determining a reverted value for the at least one instance of reverted map data based on the reverted value sum and the instance counter associated with the at least one instance of reverted map data.

In an example embodiment, the digital map is configured for use in performing one or more positioning and/or navigation-related functions.

In an example embodiment, the copy of the instance of contributed data is stored by a computing entity (e.g., collecting device and/or third-party device) associated with an entity that contributed the instance of contributed data.

In an example embodiment, the at least one memory and the computer program code and/or instructions are further configured to, with the processor, cause the apparatus to at least cause the copy of the instance of contributed data stored by the computing entity to be at least one of (a) deleted from memory of the computing entity or (b) flagged as having been de-aggregated from the digital map.

In an example embodiment, the reversion trigger indicates that a potential inaccuracy of the at least one instance of contributed data has been detected.

In an example embodiment, the reversion trigger is detected by a computing entity associated with an entity that contributed the instance of contributed data responsive to at least one of (a) receiving user input initiating the reversion trigger or (b) a reversion trigger initiation generated by an application operating on the computing entity.

In an example embodiment, the reversion trigger is identified responsive to determining that a quality index corresponding to the instance of map data indicates that the instance of map data is of lower quality after the instance of map data was updated based on the instance of contributed data than before the instance of map data was updated based on the instance of contributed data.

In an example embodiment, updating the at least one instance of map data based on the instance of contributed data comprises generating and storing a hash of the instance of contributed data in a hash registry, the method further comprising at least one of (a) deleting the hash of the instance of contributed data from the hash registry or (b) flagging the hash of the instance of contributed data in the hash registry to indicate that the instance of contributed data has been de-aggregated from the digital map.

In an example embodiment, the at least one instance of contributed data is part of a group of instances of contributed data comprising a plurality of instances of contributed data, obtaining a copy of the at least one instance of contributed data comprises obtaining a copy of each of respective instance of contributed data of the plurality of instances of contributed data, determining at least one instance of reverted map data comprises determining one or more instances of reverted map data corresponding to respective ones of the plurality of instances of contributed data.

In an example embodiment, updating the at least one instance of map data based on the plurality of instances of contributed data comprises generating and storing a hash of the plurality of instances of contributed data in a hash registry, the method further comprising at least one of (a) deleting the hash of the plurality of instances of contributed data from the hash registry or (b) flagging the hash of the plurality of instances of contributed data in the hash registry to indicate that respective instances of contributed data of the plurality of instances of contributed data have been de-aggregated from the digital map.

In an example embodiment, the instance of contributed data comprises an instance of radio observation data comprising information characterizing an observation of a radio node by a collecting device and an instance of location data indicating the location of the collecting device when the radio node was observed.

In an example embodiment, the information characterizing the observation of the radio node by the collecting device comprises at least one of (a) a radio node identifier, (b) an observed signal strength, or (c) an observed time parameter.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions configured, when executed by a processor of an apparatus (e.g., a network device), to cause the apparatus to, after at least one instance of map data of a digital map has been generated or updated by aggregating at least a portion of an instance of contributed data with at least portions of one or more other instances of contributed data, detect a reversion trigger corresponding to the instance of contributed data. The computer-readable program code and/or instructions portions comprise executable portions further configured, when executed by a processor of an apparatus, to cause the apparatus to obtain a copy of the instance of contributed data; and determine at least one instance of reverted map data based on at least a portion of the copy of the instance of contributed data and the at least one instance of map data. The at least one instance of reverted map data comprises values corresponding to a de-aggregation of the instance of contributed data from the at least one instance of map data. The computer-readable program code and/or instructions portions comprise executable portions further configured, when executed by a processor of an apparatus, to cause the apparatus to store and/or provide the at least one instance of reverted map data as part of the digital map.

In an example embodiment, the at least one instance of map data is associated with an instance counter indicating the number of instances of contributed data that have been aggregated to generate the at least one instance of map data and generating the at least one instance of reverted map data comprises decrementing the instance counter associated with the at least one instance of map data to determine a value of the instance counter associated with the at least one instance of reverted map data.

In an example embodiment, de-aggregation of the instance of contributed data from the at least one instance of map data comprises determining a value sum based on the instance of map data and the instance counter associated with the instance of map data, subtracting an observation value of the instance of contributed data from the value sum to generate a reverted value sum, and determining a reverted value for the at least one instance of reverted map data based on the reverted value sum and the instance counter associated with the at least one instance of reverted map data.

In an example embodiment, the digital map is configured for use in performing one or more positioning and/or navigation-related functions.

In an example embodiment, the copy of the instance of contributed data is stored by a computing entity (e.g., collecting device and/or third-party device) associated with an entity that contributed the instance of contributed data.

In an example embodiment, the computer-readable program code and/or instructions portions comprise executable portions further configured, when executed by a processor of an apparatus, to cause the apparatus to cause the copy of the instance of contributed data stored by the computing entity to be at least one of (a) deleted from memory of the computing entity or (b) flagged as having been de-aggregated from the digital map.

In an example embodiment, the reversion trigger indicates that a potential inaccuracy of the at least one instance of contributed data has been detected.

In an example embodiment, the reversion trigger is detected by a computing entity associated with an entity that contributed the instance of contributed data responsive to at least one of (a) receiving user input initiating the reversion trigger or (b) a reversion trigger initiation generated by an application operating on the computing entity.

In an example embodiment, the reversion trigger is identified responsive to determining that a quality index corresponding to the instance of map data indicates that the instance of map data is of lower quality after the instance of map data was updated based on the instance of contributed data than before the instance of map data was updated based on the instance of contributed data.

In an example embodiment, updating the at least one instance of map data based on the instance of contributed data comprises generating and storing a hash of the instance of contributed data in a hash registry, the method further comprising at least one of (a) deleting the hash of the instance of contributed data from the hash registry or (b) flagging the hash of the instance of contributed data in the hash registry to indicate that the instance of contributed data has been de-aggregated from the digital map.

In an example embodiment, the at least one instance of contributed data is part of a group of instances of contributed data comprising a plurality of instances of contributed data, obtaining a copy of the at least one instance of contributed data comprises obtaining a copy of each of respective instance of contributed data of the plurality of instances of contributed data, determining at least one instance of reverted map data comprises determining one or more instances of reverted map data corresponding to respective ones of the plurality of instances of contributed data.

In an example embodiment, updating the at least one instance of map data based on the plurality of instances of contributed data comprises generating and storing a hash of the plurality of instances of contributed data in a hash registry, the method further comprising at least one of (a) deleting the hash of the plurality of instances of contributed data from the hash registry or (b) flagging the hash of the plurality of instances of contributed data in the hash registry to indicate that respective instances of contributed data of the plurality of instances of contributed data have been de-aggregated from the digital map.

In an example embodiment, the instance of contributed data comprises an instance of radio observation data comprising information characterizing an observation of a radio node by a collecting device and an instance of location data indicating the location of the collecting device when the radio node was observed.

In an example embodiment, the information characterizing the observation of the radio node by the collecting device comprises at least one of (a) a radio node identifier, (b) an observed signal strength, or (c) an observed time parameter.

According to yet another aspect, an apparatus (e.g., network device) is provided. In an example embodiment, the apparatus comprises means for, after at least one instance of map data of a digital map has been generated or updated by aggregating at least a portion of an instance of contributed data with at least portions of one or more other instances of contributed data, detecting a reversion trigger corresponding to the instance of contributed data. The apparatus comprises means for obtaining a copy of the instance of contributed data. The apparatus comprises means for determining at least one instance of reverted map data based on at least a portion of the copy of the instance of contributed data and the at least one instance of map data. The at least one instance of reverted map data comprises values corresponding to a de-aggregation of the instance of contributed data from the at least one instance of map data. The apparatus comprises means for at least one of storing or providing the at least one instance of reverted map data as part of the digital map.

According to another aspect, a method performed by a device or apparatus operated by, on behalf of, and/or in association with a contributing entity is provided. The method comprises storing, in a computer-readable memory of the device or apparatus, one or more instances of contributed data. The one or more instances of contributed data have been provided for receipt by a network device for aggregation into at least one instance of map data of a geographic database. The method further comprises accessing, by one or more processors of the device or apparatus, the one or more instances of contributed data; causing, by the one or more processors, the one or more instances of contributed data to be provided for receipt by a network device; and receiving, by the one or more processors, at least one instance of reverted map data. The at least one instance of reverted map data was determined by de-aggregating at least one of the one or more instances of contributed data from the at least one instance of map data. The method further comprises at least one of (a) causing, by the one or more processors, the at least one instance of reverted map data to be stored in the computer-readable memory, or (b) using, by the one or more processors, the at least one instance of reverted map data to perform at least one positioning and/or navigation-related function.

According to still another aspect, an apparatus (e.g., collecting device and/or third-party device) is provided. In an example embodiment, the apparatus comprises at least one processor and at least one memory storing computer program code and/or instructions. The at least one memory and the computer program code and/or instructions are configured to, with the processor, cause the apparatus to at least store, in the at least one memory, one or more instances of contributed data. The one or more instances of contributed data have been provided for receipt by a network device for aggregation into at least one instance of map data of a geographic database. The at least one memory and the computer program code and/or instructions are further configured to, with the processor, cause the apparatus to at least access the one or more instances of contributed data; cause the one or more instances of contributed data to be provided for receipt by a network device; and receive at least one instance of reverted map data. The at least one instance of reverted map data was determined by de-aggregating at least one of the one or more instances of contributed data from the at least one instance of map data. The at least one memory and the computer program code and/or instructions are further configured to, with the processor, cause the apparatus to perform at least at least one of (a) cause the at least one instance of reverted map data to be stored in the at least one memory, or (b) use the at least one instance of reverted map data to perform at least one positioning and/or navigation-related function.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions configured, when executed by a processor of an apparatus (e.g., a collecting device and/or third-party device), to cause the apparatus to store one or more instances of contributed data in a non-transitory computer-readable memory. The one or more instances of contributed data have been provided for receipt by a network device for aggregation into at least one instance of map data of a geographic database. The computer-readable program code and/or instructions portions comprise executable portions further configured, when executed by the processor of the apparatus, to cause the apparatus to access the one or more instances of contributed data; cause the one or more instances of contributed data to be provided for receipt by a network device; and receive at least one instance of reverted map data. The at least one instance of reverted map data was determined by de-aggregating at least one of the one or more instances of contributed data from the at least one instance of map data. The computer-readable program code and/or instructions portions comprise executable portions further configured, when executed by the processor of the apparatus, to cause the apparatus to perform at least at least one of (a) cause the at least one instance of reverted map data to be stored in the at least one memory, or (b) use the at least one instance of reverted map data to perform at least one positioning and/or navigation-related function.

According to yet another aspect, an apparatus (e.g., collecting device and/or third-party device) is provided. In an example embodiment, the device comprises means for storing, in a non-transitory computer-readable memory, one or more instances of contributed data. The one or more instances of contributed data have been provided for receipt by a network device for aggregation into at least one instance of map data of a geographic database. The apparatus comprises means for accessing the one or more instances of contributed data. The apparatus comprises means for causing the one or more instances of contributed data to be provided for receipt by a network device. The apparatus comprises means for receiving at least one instance of reverted map data. The at least one instance of reverted map data was determined by de-aggregating at least one of the one or more instances of contributed data from the at least one instance of map data. The apparatus comprises means for performing at least one of (a) causing the at least one instance of reverted map data to be stored in the computer-readable memory, or (b) using the at least one instance of reverted map data to perform at least one positioning and/or navigation-related function.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 illustrates an example system of one embodiment of the present disclosure;

FIG. 2A is a block diagram of a network device that may be specifically configured in accordance with an example embodiment;

FIG. 2B is a block diagram of a collecting device that may be specifically configured in accordance with an example embodiment;

FIG. 2C is a block diagram of a third-party device that may be specifically configured in accordance with an example embodiment;

FIG. 3 is a flowchart illustrating operations performed, such as by the network device of FIG. 2A, in accordance with an example embodiment;

FIG. 4A illustrates an example map data record comprising instances of map data, in accordance with an example embodiment;

FIG. 4B illustrates an example instance of contributed data, in accordance with an example embodiment;

FIG. 5 is a flowchart illustrating operations performed, such as by the network device of FIG. 2A, to generate and/or update one or more map data records and/or instances of map data based on a group of instances of contributed data, in accordance with an example embodiment;

FIG. 6 is a flowchart illustrating operations performed, such as by the network device of FIG. 2A, to generate one or more reverted map data records and/or instances of reverted map data based on a detected reversion trigger, in accordance with an example embodiment; and

FIG. 7 is a flowchart illustrating operations performed, such as by the collecting device of FIG. 2B or the third-party device of FIG. 2C, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

I. General Overview

Various embodiments provide methods, apparatus, systems, and computer program products for mitigating or otherwise overcoming the effects of potentially inaccurate instances of contributed data on map data generated by aggregating instances of contributed data. For example, various embodiments provide methods, apparatus, systems, and computer program products for removing instances of contributed data that were aggregated and/or integrated with other instances of contributed data and/or existing instances of map data to generate and/or update instances of map data. For example, in an example embodiment, an instance of contributed data and/or a group of instances of contributed data are received and aggregated and/or integrated with respective other instances of contributed data and/or respective instances of existing map data to generate and/or update respective instances of map data. In various embodiments, respective counters associated with the instances of map data are generated and/or incremented, a hash of the instance of contributed data and/or group of instances of contributed data is generated and stored to a hash registry, and/or the like.

Due to memory limitations, the instances of contributed data and/or group of instances of contributed data are generally not stored in their original form by a network device operating to generated, update, and/or maintain the geographic database. For example, a geographic database may be generated and/or updated based on millions of instances of contributed data. Rather, the network device may only store the result of aggregating the instances of contributed data as the generated and/or updated instances of map data. Thus, a technical problem exists as to how to mitigate the effect of a potentially inaccurate instance of contributed data and/or group of instances of contributed data on the accuracy of the map data of the geographic database. For example, technical problems exist regarding how to remove an instance of contributed data and/or group of instances of contributed data from the map data of the geographic database.

Various embodiments provide technical solutions to these technical problems. Additionally, various embodiments provide safe guards against bad faith actors taking advantage of the enabled ability to remove instances of contributed data from the geographic database to sabotage the accuracy and/or coverage of the geographic database.

In various embodiments, a data contributor stores copies of instances of contributed data and/or groups of instances of contributed data contributed by the contributor (e.g., in a memory of a collecting device that collected the instance(s) of contributed data and/or a corresponding third-party device). Due to storage limitations and the large number of instances of contributed data used by a network device to generate and/or update the map data of the geographic database, the network device may only store compact representations of the instances of contributed data and/or groups of instances of contributed data used to generate and/or update the map data. In various embodiments, the compact representation is not loss-less such that the original instance(s) of contributed data may not be deterministically determined based on the compact representation thereof. For example, in an example embodiment, the network device stores a hash of an instance of contributed data and/or group of instances of contributed data that have been used to generate and/or update the geographic database.

In various embodiments, a reversion trigger corresponding to an instance of contributed data or a group of instances of contributed data is received, thereby indicating that the instance of contributed data or the group of instances of contributed data are potentially inaccurate and/or are otherwise being recalled. In various embodiments, a copy of the instance of contributed data and/or group of instances of contributed data are obtained. For example, the reversion trigger may include a copy of the instance of contributed data and/or group of instances of contributed data, a pointer, instance or group identifier, and/or index that may be used to access and/or request a copy of the instance of contributed data and/or group of instances of contributed data, and/or the like. One or more respective instances of map data are identified corresponding to the instance of contributed data and/or the group of instances of contributed data being recalled. Based on the copy of the respective instance of contributed data and the respective instance of map data, a respective instance of reverted map data is generated by de-aggregating the respective instance of contributed data from the respective instance of map data. The respective instance of reverted map data is stored and/or provided, for example, for use in performing a positioning and/or navigation-related function.

In an example embodiment, the hash corresponding to the instance of contributed data and/or group of instances of contributed data is deleted and/or flagged to indicate that the corresponding instance(s) of contributed data have been de-aggregated and/or de-integrated from the geographic database. In an example embodiment, the copy of the instance of contributed data and/or group of instances of contributed data is caused to be deleted and/or flagged to indicate that the corresponding instance(s) of contributed data have been de-aggregated and/or de-integrated from the geographic database.

In various embodiments, prior to generating the instance(s) of reverted map data, the network device may confirm that instance of contributed data and/or group of instances of contributed data indicated by the reversion trigger were used to update the geographic database and/or have not already been removed from the geographic database. For example, by checking that the hash of the instance of contributed data and/or group of instances of contributed data indicated by the reversion trigger is present in the hash registry (and not flagged as already having been de-aggregated and/or de-integrated) the network device may safeguard against bad faith actions.

Thus, various embodiments provide improvements to the field of generating, updating, and/or maintaining a geographic database. For example, various embodiments provide improvements to the field of using crowd-sourced data to generate, update, and/or maintain a geographic database.

In various embodiments, the geographic database, map data records, and/or instance of map data are configured for use in performing positioning and/or navigation-related functions. Some non-limiting examples of positioning and/or navigation-related functions include providing a route or information corresponding to a geographic area (e.g., via a user interface), localization, localization visualization, route determination, lane level route determination, operating a vehicle along at least a portion of a route, operating a vehicle along at least a portion of a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

In various embodiments, the geographic database comprises a radio map. For example, in an example embodiment, the radio map may be configured for use in performing radio-based positioning and/or navigation. For example, the radio map may include map data records and/or instances of map data that indicate the location of respective radio nodes, the observed signal strength of radio nodes at various positions within the broadcast and/or coverage area of the respective radio nodes, observed time parameter(s) such as one way travel time or roundtrip travel time for observed radio signals within the broadcast and/or coverage area of respective radio nodes, radio types of respective radio nodes, broadcast channels and/or frequency bands of respective radio nodes, transmission intervals of respective radio nodes, and/or the like. For example, in an example embodiment, an instance of contributed data comprises radio data such as a radio node identifier for a radio node that generated and/or transmitted an observed radio signal, an observed signal strength for the observed radio signal, an observed time parameter for the observed radio signal, a position estimate for the location of a collection device when the radio signal was observed, and/or the like. The instances of map data of a map data record corresponding to a radio node and/or a location may be generated and/or updated by aggregating new observations of radio signals generated and/or transmitted by the radio node and observed by collecting devices at or near the location.

In various embodiments, the geographic database comprises a feature map. For example, in an example embodiment, the feature map may be configured for use in performing visual odometry-based positioning and/or navigation. For example, the feature map may include map data records and/or instances of map data that indicate the location of respective features, a feature type, the observed characteristics of the respective features (e.g., size, color, reflectivity, and/or the like as appropriate for the feature type), and/or the like. For example, in an example embodiment, an instance of contributed data comprises feature observation data such as a feature identifier configured to identify an observed feature, a feature type, observed characteristics of the feature, a position estimate corresponding to the observed location of the feature, and/or the like. The instances of map data of a map data record corresponding to a feature and/or a location may be generated and/or updated by aggregating new observations of the feature by collecting devices at or near the location.

In various embodiments, the geographic database may comprise other classes or categories of data that may be used to perform positioning and/or navigation-related functions. In such embodiments, the map data records comprise instances of map data that are appropriate for the corresponding class or category of data and the instances of contributed data include corresponding data regarding observations generated, collected, captured, measured, and/or the like by a collecting device.

II. Example System Architecture

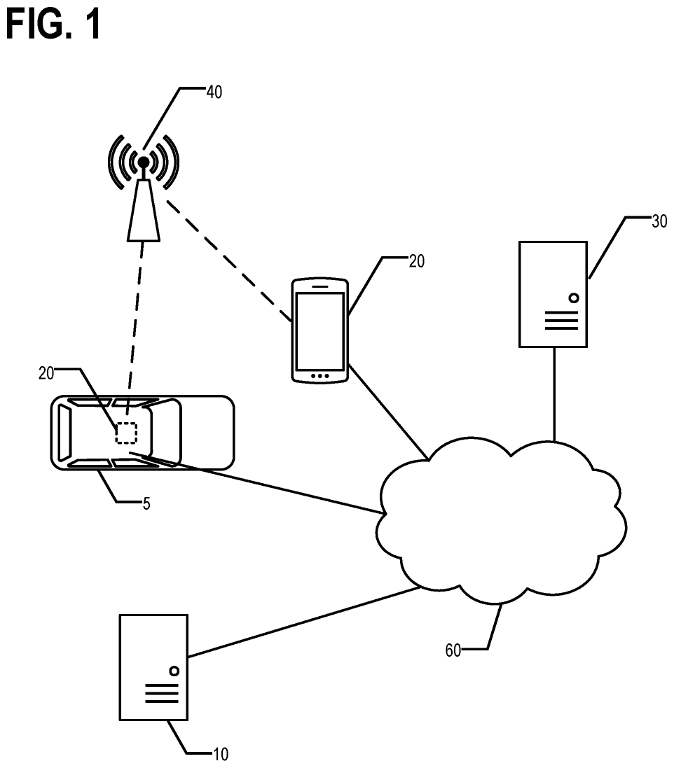

FIG. 1 provides an illustration of an example system that can be used in conjunction with various embodiments of the present invention. As shown in FIG. 1, the system includes one or more network devices 10, one or more collecting devices 20, one or more third-party devices 30, one or more networks 60, and/or the like. In an example embodiment, the network device 10 is a server, group of servers, distributed computing system, part of a cloud-based computing system, and/or other computing system. In various embodiments, collecting devices 20 are user devices, mobile devices, deployed infrastructure devices, and/or the like. For example, in an example embodiment, a collecting device 20 may be a mobile phone, smartphone, personal digital assistant (PDA), navigation system, tablet, laptop, router, relay, edge device, and/or the like. In an example embodiment, a collecting device 20 may be onboard a respective vehicle 5. In an example embodiment, the third-party device 30 is a server, group of servers, distributed computing system, part of a cloud-based computing system, and/or other computing system. In various embodiments, the network device 10 communicates with one or more collecting devices 20 and/or third-party devices 30 via one or more wired or wireless networks 60.n

For example, in various embodiments, the collecting device 20 may be an in-vehicle navigation system, vehicle control system, a mobile computing device, a mobile data gathering platform, and/or the like. For example, a collecting device 20 may be an in vehicle navigation system mounted within and/or be onboard a vehicle 5 such as a motor vehicle, non-motor vehicle, automobile, car, scooter, truck, van, bus, motorcycle, bicycle, Segway, golf cart, and/or the like. In an example embodiment, the collecting device 20 is a vehicle control system configured to autonomously drive a vehicle 5, assist in control of a vehicle 5 (e.g., advanced driver assistance system (ADAS)), monitor various aspects of the vehicle 5 (e.g., fault conditions, motor oil status, battery charge level, fuel tank fill level, and/or the like) and/or the like. In various embodiments, the collecting device 20 is configured to autonomously drive a vehicle 5 and may perform multiple functions that are similar to those performed by a collecting device 20 configured to be an ADAS (e.g., lane keeping, lane change assistance, maintaining a lane, merging, etc.). In some embodiments, a collecting device 20 is onboard a personal vehicle, commercial vehicle, public transportation vehicle, fleet vehicle, and/or other vehicle. In various embodiments, a collecting device 20 is a smart phone, tablet, laptop, PDA, mobile computing device, navigation system, vehicle control system (e.g., ADAS or automated vehicle control system), and/or the like. In an example embodiment, a collecting device 20 is onboard a vehicle 5 and is used to perform one or more positioning and/or navigation-related functions corresponding to the vehicle 5 traversing at least a portion of a traversable network (e.g., a road network).

In various embodiments, the system further includes one or more radio nodes 40. In various embodiments, the radio nodes 40 are wireless network access points and/or gateways such as Wi-Fi network access points, cellular network access points, Bluetooth access points, and/or other radio frequency-based network access points. In an example embodiment, the radio nodes 40 include various other beacons configured to generate and/or transmit radio signals (e.g., beacons, radio frequency identification (RFID) tags, and/or the like).

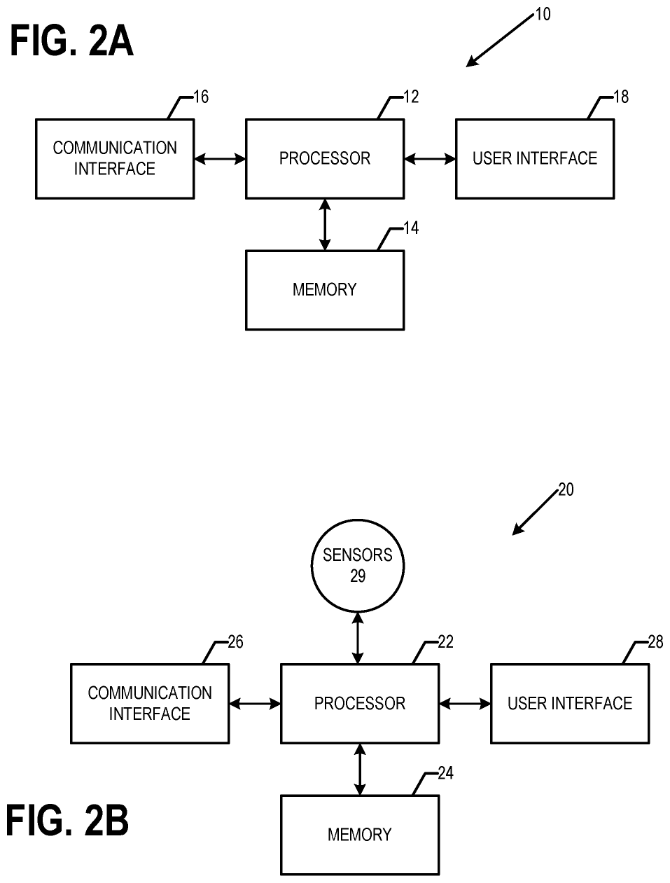

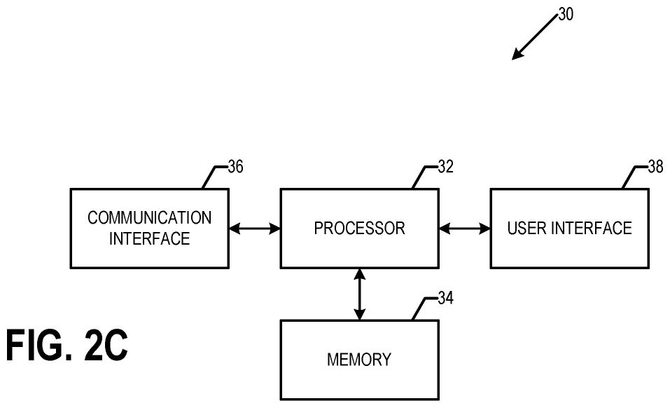

In an example embodiment, a network device 10 may comprise components similar to those shown in the example network device 10 diagrammed in FIG. 2A. In an example embodiment, the network device 10 is configured to obtain instances of contribution data and/or groups of instances of contribution data, generate and/or update instances of map data based on the instances of contribution data and/or groups of instances of contribution data, detect a reversion trigger indicating that instances of contribution data and/or groups of instances of contribution data should be de-aggregated and/or de-integrated from respective instances of map data, generate respective instances of reverted map data by de-aggregating and/or de-integrating the indicated instances of contribution data and/or groups of instances of contribution data from the respective instances of map data, store or provide instances of reverted map data, use one or more instances of reverted map data to perform positioning and/or navigation-related functions, and/or the like.

For example, as shown in FIG. 2A, the network device 10 may comprise a processor 12, memory 14, a user interface 18, a communications interface 16, and/or other components configured to perform various operations, procedures, functions, or the like described herein. In various embodiments, the network device 10 stores a geographic database (e.g., a, digital map) such as and/or comprising a radio map, feature map, and/or the like; computer program code and/or instructions for performing various functions described herein, and/or the like (e.g., in memory 14), for example. In at least some example embodiments, the memory 14 is non-transitory.

In an example embodiment, the collecting device 20 is configured to capture instances of contributed data (e.g., instances of radio data, instances of feature data, and/or the like), provide the instances of contributed data, and/or the like. In various embodiments, the collecting device 20 is operated by and/or on behalf of an individual or entity (e.g., organization, corporation, department, group, and/or the like) that is contributing instances of contribution data for use in generating and/or updating the geographic database.

In an example embodiment, the collecting device 20 is a mobile computing device such as a smartphone, tablet, laptop, PDA, navigation system, vehicle control system, an Internet of things (IoT) device, and/or the like. In an example embodiment, the collecting device 20 is an infrastructure device such as a modem, router, relay, edge device, and/or the like. In an example embodiment, as shown in FIG. 2B, the collecting device 20 may comprise a processor 22, memory 24, a communications interface 26, a user interface 28, one or more sensors 29 and/or other components configured to perform various operations, procedures, functions or the like described herein. In various embodiments, the collecting device 20 stores at least a portion of one or more digital maps (e.g., geographic databases, positioning maps, and/or the like) and/or computer executable instructions for generating/capturing and/or providing instances of contributed data, and/or the like in memory 24. In at least some example embodiments, the memory 24 is non-transitory.

In various embodiments, the sensors 29 comprise one or more inertial measurement unit (IMU) and/or motion sensors, one or more global navigation satellite system (GNSS) sensors, one or more radio sensors, and/or other sensors. In an example embodiment, the one or more IMU sensors comprise one or more accelerometers, gyroscopes, magnetometers, barometers, and/or the like. In various embodiments, the one or more GNSS sensor(s) are configured to communicate with one or more GNSS satellites and determine GNSS-based position estimates and/or other information based on the communication with the GNSS satellites. In various embodiments, the one or more radio sensors comprise one or more radio interfaces configured to observe and/or receive signals generated and/or transmitted by one or more radio nodes 40 and/or other computing entities. For example, the one or more interfaces may be configured (possibly in coordination with processor 22) to determine a locally unique identifier, globally unique identifier, observed characteristics of a radio signal generated and/or transmitted by a radio node 40, and/or operational parameters of a radio node 40 observed by the radio sensor(s). As used herein, a radio sensor observes a radio node 40 by receiving, capturing, measuring and/or observing a signal generated and/or transmitted by the radio node 40. In an example embodiment, the interface of a radio sensor may be configured to observe one or more types of signals such as generated and/or transmitted in accordance with one or more protocols such as 5G new radio (NR), general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), LTE Advanced (LTE-A), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor may be configured to observe signals of one or more modern global cellular formats such as GSM, WCDMA, TD-SCDMA, LTE, LTE-A, CDMA, NB-IoT and/or non-cellular formats such as wireless local area network (WLAN), Bluetooth, Bluetooth Low Energy (BLE), Zigbee, Lora, and/or the like. For example, the interface(s) of the radio senor(s) may be configured to observe radio, millimeter, microwave, and/or infrared wavelength signals. In an example embodiment, the interface of radio sensor may be coupled to and/or part of a communications interface 26. In various embodiments, the sensors 29 may further comprise one or more image sensors configured to capture visual samples, such as digital camera(s), three dimensional (3D) cameras, 360° cameras, and/or image sensors. In various embodiments, the one or more sensors 29 may comprise various other sensors such as two dimensional (2D) and/or 3D light detection and ranging (LiDAR)(s), long, medium, and/or short range radio detection and ranging (RADAR), ultrasonic sensors, electromagnetic sensors, (near-) infrared (IR) cameras. In an example embodiment, sensors 29 comprise one or more audio sensors, such as a microphone.

In an example embodiment, the third-party device 30 is configured to receive instances of contribution data and/or groups of instances of contribution data, store the instances of contribution data and/or groups of instances of contribution data, provide (e.g., transmit) the instances of contribution data and/or groups of instances of contribution data, audit the received instances of contribution data and/or groups of instances of contribution data and/or map data to identify potential inaccuracies in the receive instances of contribution data and/or groups of instances of contribution data, receive indications of user input identifying received instances of contribution data and/or groups of instances of contribution data as potentially inaccurate, provide (e.g., transmit) a reversion trigger, receive reversion instructions for deleting or flagging de-aggregated and/or de-integrated the instances of contribution data and/or groups of instances of contribution data, delete and/or flag de-aggregated and/or de-integrated instances of contribution data and/or groups of instances of contribution data, and/or the like. In various embodiments, the third-party device 30 is operated by and/or on behalf of the individual or entity (e.g., organization, corporation, department, group, and/or the like) that is contributing instances of contribution data for use in generating and/or updating the geographic database.

In an example embodiment, the third-party device 30 is a server, group of servers, distributed computing system, part of a cloud-based computing system, desktop computing system, and/or other computing system. In an example embodiment, as shown in FIG. 2C, the third-party device 30 may comprise a processor 32, memory 34, a communications interface 36, a user interface 38, and/or other components configured to perform various operations, procedures, functions or the like described herein. In various embodiments, the third-party device 30 stores instances of contributed data and/or groups of instances of contributed data and/or computer executable instructions for providing and/or maintaining instances of contributed data, and/or the like in memory 34. In at least some example embodiments, the memory 34 is non-transitory.

Each of the components of the system may be in electronic communication with, for example, one another over the same or different wireless or wired networks 60 including, for example, a wired or wireless Personal Area Network (PAN), Local Area Network (LAN), Metropolitan Area Network (MAN), Wide Area Network (WAN), cellular network, and/or the like. In an example embodiment, a network 60 comprises the automotive cloud, digital transportation infrastructure (DTI), radio data system (RDS)/high definition (HD) radio or other digital radio system, and/or the like. For example, a collecting device 20 and/or a third-party device 30 may be in communication with one another and/or a network device 10 via the network 60. For example, a collecting device 20 and/or third-party device 30 may communicate with the network device 10 via a network, such as the Cloud. For example, the Cloud may be a computer network that provides shared computer processing resources and data to computers and other devices connected thereto. For example, the collecting device 20 captures instances of contributed data and/or group(s) of instances of contributed data and provides the instances of contributed data and/or group(s) of instances of contributed data such that the network device 10 and/or the third-party device 30 receives the instances of contributed data and/or group(s) of instances of contributed data via the network 60. In an example embodiment, the third-party device 30 receives instances of contributed data and/or group(s) of instances of contributed data and provides the instances of contributed data and/or group(s) of instances of contributed data such that the network device 10 receives the instances of contributed data and/or group(s) of instances of contributed data via the network 60. For example, the network device 10 may be configured to receive instances of contributed data and/or group(s) of instances of contributed data and/or provide map data including one or more instances of reverted map data via the network 60.

Certain example embodiments of the network device 10, collecting device 20, and third-party device 30 are described in more detail below with respect to FIGS. 2A, 2B, and 2C.

III. Example Operation(s)

In various embodiments, one or more collecting devices 20 associated with an entity capture, collect, and/or generate one or more instances of contributed data. In various embodiments, an instance of contributed data describes at least a portion of the environment about the collecting device 20 when the collecting device 20 captured, collected, and/or generated the instance of contribution data. For example, in an example embodiment, an instance of contributed data is an instance of radio data and comprises an instance of radio observation data and an instance of location data. The instance of radio observation data comprises information characterizing observations of one or more respective radio nodes 40. For example, the information characterizing the observation of a radio node 40 by a collecting device 20 may include a radio node identifier configured to locally and/or globally identify the radio node, an observed signal strength, an observed time parameter (e.g., one way travel time, roundtrip travel time), a transmission channel and/or frequency-band, a transmission interval, a radio type (e.g., Wi-Fi, Bluetooth, cellular, 5G, etc.), and/or other information characterizing the radio signal observed by the collecting device 20 and generated and/or transmitted by the radio node 40. The instance of location data indicates the location of the collecting device 20 when the collecting device 20 observed the radio node(s) 40 for which the observations are characterized by the associated instance of radio observation data.

In various embodiments, the one or more collecting devices 20 provide the instances of contributed data. For example, the one or more collecting devices 20 may provide (e.g., transmit) individual instances of contributed data as the instances of contributed data are captured, collected, generated, and/or the like or the one or more collecting devices 20 may provide (e.g., transmit) batches or groups of instances of contributed data. In various embodiments, the one or more collecting devices 20 provide the instances of contributed data (and/or batches or groups thereof) such that the network device 10 and/or the third-party device 30 receives the instances of contributed data (and/or batches or groups thereof). In various embodiments, the third-party device 30 stores (e.g., in memory 34) the instances of contributed data (and/or batches or groups thereof). In an embodiment where the collecting device 20 does not provide the instances of contributed data (and/or batches or groups thereof) for receipt by the network device 10, the third-party device 30 may batch or group the instances of contributed data (if they are not already batched or grouped, for example) and provides (e.g., transmits) the instances of contributed data (and/or batches or groups thereof) such that the network device 10 receives the instances of contributed data (and/or batches or groups thereof).

When the network device 10 receives the instances of contributed data (and/or batches or groups thereof), the network device 10 queues the instances of contributed data (and/or batches or groups thereof) for processing and processes the instances of contributed data (and/or batches or groups thereof) accordingly. In various embodiments, to process an instance of contributed data, the network device 10 identifies a relevant instance of existing map data and/or one or more other relevant instances of contributed data. For example, the relevant instance of existing map data and/or one or more relevant instances of contributed data are associated with a same location (e.g., satisfy distance criteria) of the instance of contribution data (e.g., as indicated by the corresponding instance of location data); correspond to a same radio node, feature; corresponds to a similar observation characteristic (e.g., observed signal strength, observed one way travel time, and/or radio observed round trip travel time when the observation is of a radio node; observed color, observed reflectivity, observed height, etc. when the observation is of a visual feature; and/or the like), and/or the like.

In various embodiments, the instance of contributed data is aggregated and/or integrated with the relevant instance of existing map data and/or the one or more relevant instances of contributed data. For example, when the instance of contributed data includes an observed signal strength for a particular radio node 40 observed from an observation location and the relevant instance of existing map data includes an aggregated and/or integrated observed signal strength for the particular radio node 40 at a particular location that, with respect to the observation location, satisfies a distance criteria, the observed signal strength for the particular radio node 40 of the instance of contributed data may be aggregated and/or integrated into the aggregated and/or integrated observed signal strength indicated by the instance of existing map data to determine an updated observed signal strength. Similarly, when one or more relevant instances of contributed data include respective observed signal strengths for the particular radio node 40 observed from locations that satisfy the distance criteria with respect to the observation location, the observed signal strengths may be aggregated (e.g., averaged) together to determine an updated observed signal strength. The various observed signal strengths (e.g., the observed signal strengths of the instance of contributed data and the one or more other instances of relevant contributed data and/or the aggregated and/or integrated observed signal strength) may be averaged, for example, to generate an instance of map data. As should be understood, the relevant instance of existing map data was generated by aggregating a plurality of instances of contributed data. A counter associated with the instance of map data is incremented and/or updated to indicate the number of instances of contributed data that have been aggregated and/or integrated to arrive at the present instance of map data. For example, the relevant instance of existing map data may have been associated with a counter of 50 and two more instances of contributed data may be aggregated and/or integrated therewith such that the updated instance of map data is associated with a counter of 52.

Due to the large number of instances of contributed data received and processed by the network device 10, the network device 10 generally does not store each individual instance of contributed data after the instance of contributed data has been aggregated and/or integrated with existing map data and/or other instances of contributed data. For example, in an example embodiment, a hash of an instance of contributed data and/or a hash of a batch or group of instances of contributed data may be generated and stored to a hash directory. However, due to memory limitations, the instances of contributed data and/or batch or group of instances of contributed data may not be stored. Thus, when an instance of contributed data and/or a batch or group of instances of contributed data are identified as potentially being inaccurate, removing the instance of contributed data and/or the batch or group of instances of contributed data poses a technical challenge.

Various embodiments provide technical solutions to these technical challenges. For example, a collecting device 20, third-party device 30, and/or network device 10 may determine that an instance of contributed data and/or a batch or group of instances of contributed data are potentially inaccurate. However, the instance(s) of contributed data have already been aggregated and/or integrated into the geographic database of the digital map. For example, a user of a collecting device 20 may determine that the collecting device 20 is not operating properly and may provide user input (e.g., via user interface 28) recalling an instance of contributed data and/or a batch or group of instances of contributed data. Responsive to receiving an indication of the user input, the collecting device 20 and/or the third-party device 30 may generate and provide a reversion trigger corresponding to and/or identifying the instance of contributed data and/or the batch(es) or group(s) of instances of contributed data that have been determined to be potentially inaccurate. In another example, a user or an application operating on a collecting device 20, third-party device 30, and/or network device 10 may determine that the digital map is of lower quality after the aggregation and/or integration of an instance of contributed data and/or a batch or group of instances of contributed data. For example, the positioning accuracy in the vicinity of the location(s) indicated by the instance(s) of location data of the instance of contributed data and/or batch(es) or group(s) of instances of contributed data may be reduced after the aggregation and/or integration of the instance of contributed data and/or batch(es) or group(s) of instances of contributed data into the map data of the geographical database compared to before the aggregation and/or integration of the instance of contributed data and/or batch(es) or group(s) of instances of contributed data into the map data of the geographical database. Responsive to such a determination, the respective collecting device 20, third-party device 30, and/or network device 10 may generate and/or provide a reversion trigger.

In various embodiments, responsive to detecting a reversion trigger, the network device 10 obtains a copy of the instance of contributed data and/or batch or group of instances of contributed data indicated by the reversion trigger. In an example embodiment, the collecting device 20 and/or third-party device 30 store the instances of contributed data and/or batches or groups of instances of contributed data contributed and/or provided (e.g., transmitted) by the collecting device 20 and/or third-party device 30 for receipt by the network device 10. In an example embodiment, when the collecting device 20 or third-party device 30 generates and provides a reversion trigger for receipt by the network device 10, a copy of the instance of contributed data and/or batch or group of instances of contributed data that have been determined and/or identified as being potentially inaccurate and/or indicated in the reversion trigger are provided along with the reversion trigger (e.g., for receipt by the network device 10). In an example embodiment, the reversion trigger comprises sufficient information (e.g., instance identifiers, capturing collecting device identifiers and timestamps or a time range, a batch or group identifier, a pointer to where the indicated instances of contributed data and/or batch or group of instances of contributed data are stored, and/or the like) such that the network device 10 may generate and provide a request for a copy of the instance(s) of contributed data and/or batch(es) or group(s) of instances of contributed data indicated in the reversion trigger. For example, the network device 10 may generate and provide (e.g., transmit) a request for a copy of the instance(s) of contributed data and/or batch(es) or group(s) of instances of contributed data indicated in the reversion trigger for receipt by the collecting device 20 or the third-party device 30. The collecting device 20 or the third-party device 30 then provides (e.g., transmits) a copy of the indicated instance(s) of contributed data and/or batch(es) or group(s) of instances of contributed data for receipt by the network device 10.

Once the network device 10 obtains the copy of the instance(s) of contributed data and/or batch(es) or group(s) of instances of contributed data indicated by the reversion trigger, the network device 10 identifies respective instances of map data into which the respective instance(s) of contributed data were aggregated and/or integrated. For example, a map data record and/or instances of map data that indicate a particular location that, with respect to an observation location indicated by an instance of location data of the instance of contributed data, satisfies a distance criteria are identified. From the identified map data record(s) and/or instance(s) of map data, an instance of map data that includes a value and/or field for a corresponding observation type (e.g., observed signal strength, observed one way travel time, observed roundtrip travel time, and/or the like in the scenario where the instance of contributed data comprises an instance of radio observation data) is identified. The observed value of the instance of contributed data may then be de-aggregated and/or de-integrated from the corresponding value of the identified instance of map data. For example, the value of a counter associated with the identified instance of map data may be multiplied by the value for the corresponding observation type of the instance of map data. The observed value may then be subtracted from the resulting product and the counter associated with the identified instance of map data may be reduced (e.g., incremented down by 1) and the difference between the resulting product and the observed value may be divided by the value of the reduced counter to generate and/or determine a reverted value. The identified instance of map data is then updated with the reverted value and the reduced counter to generate an instance of reverted map data from which the instance of contributed data has been de-aggregated and/or de-integrated. The instance of reverted map data may then be stored and/or provided (e.g., transmitted) for use (e.g., by user devices, mobile devices, navigation devices, collecting devices 20, the network device 10, and/or the like) in performing positioning and/or navigation-related functions, including but not limited radio-based positioning, visual odometry, and/or the like.

Various embodiments further provide technical improvements that prevent the accidental multi-removal of an instance of contributed data and/or a batch or group of instances of contributed data and/or bad faith actions such as recalling instances of contributed data and/or batches or groups of instances of contributed data multiple times and/or that were never aggregated and/or integrated into the geographic database of the digital map. For example, in various embodiments, when an instance of contributed data and/or a batch or group of instances of contributed data are aggregated and/or integrated into the geographic database of the digital map, a hash of the instance of contributed data and/or batch or group of instances of contributed data is generated and/or determined (e.g., using a selected hashing function). The hash of the instance of contributed data and/or batch or group of instances of contributed data is then stored to a hash registry (e.g., stored in memory 14).

In various embodiments, when the network device 10 obtains a copy of an instance of contributed data and/or batch or group of instances of contributed data indicated in a reversion trigger, the network device 10 generates and/or determines a hash (using the selected hashing function) of the instance of contributed data and/or batch or group of instances of contributed data indicated in a reversion trigger and determines whether a hash that is present in the hash registry matches the generated and/or determined hash before de-aggregating the instance(s) of contributed data from the geographic database. Once the instance(s) of contributed data are de-aggregated and/or de-integrated from the geographic database, the hash stored in the hash registry that matches the determined and/or generated hash is deleted or flagged to indicate that the corresponding instance(s) of contributed data have been de-aggregated and/or de-integrated from the geographic database, in an example embodiment. Thus, only instances of contributed data and/or batches or groups of instances of contributed data for which a matching hash is stored in the hash registry (and not flagged as already having been de-aggregated and/or de-integrated) are de-aggregated and/or de-integrated from the geographical database, in various embodiments.

In various embodiments, once the network device 10 de-aggregates and/or de-integrates the instance(s) of contributed data from the geographic database, the network device 10 generates and provides reversion instructions for receipt by the collecting device 20 and/or third-party device 30 that provided the copy of the instance of contributed data and/or batch or group of instances of contributed data. When the collecting device 20 and/or third-party device 30 receives and processes the reversion instructions, the collecting device 20 and/or contribute device 30 is caused to delete the instance of contributed data and/or batch or group of instances of contributed data from its memory 24, 34 and/or to flag the instance of contributed data and/or batch or group of instances of contributed data stored in its memory 24, 34 to indicate that the corresponding instance(s) of contributed data have been de-aggregated and/or de-integrated from the geographic database, in an example embodiment. Thus, accidental multiple de-aggregation and/or de-integrations of the same instances of contributed data are prevented, in various embodiments.

Thus, various embodiments provide further improvements to the field of crowd-sourcing map data; generating, updating, and/or maintaining a digital map and/or geographic database using crowd-sourced data; and/or generating, updating, and/or maintaining digital maps and/or geographic databases configured for use in performing positioning and/or navigation functions.

### A. Example Operation of a Network Device to Generate Reverted Map Data

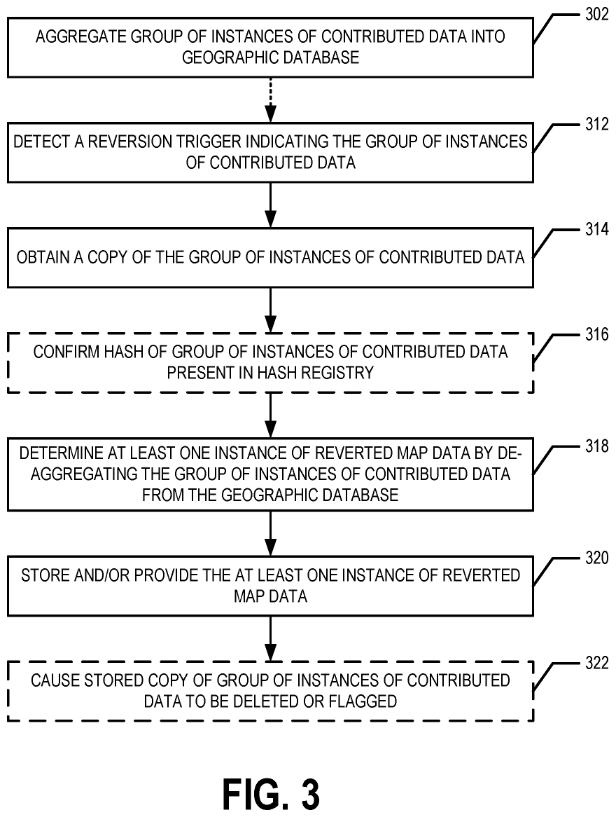

FIG. 3 provides a flowchart illustrating processes, procedures, operations, and/or the like, performed by a network device 10, for example, for generating reverted map data. FIG. 3 is described herein using a group of instances of contributed data. In various embodiments, a group of instances of contributed data is a batch of instances of contributed data that were collected by the same collecting device 20 and/or a plurality of collecting devices 20 during a period of time, a particular collecting session, in a particular geographic area during a period of time, and/or the like. As should be understood, the processes, procedures, operations and/or the like described with respect to FIG. 3 could be similarly performed on individual instances of contributed data.

Starting at block 302, a network device 10 aggregates and/or integrates a group of instances of contributed data into a geographic database of a digital map. For example, the network device 10 comprises means, such as processor 12, memory 14, communication interface 16, and/or the like, for aggregating a group of instances of contributed data into the geographic database of a digital map. For example, the network device 10 generates and/or determines one or more instances of map data by aggregating respective instances of contributed data of the group of instances of contributed data with relevant instances of existing map data and/or other instances of contributed data that are relevant.

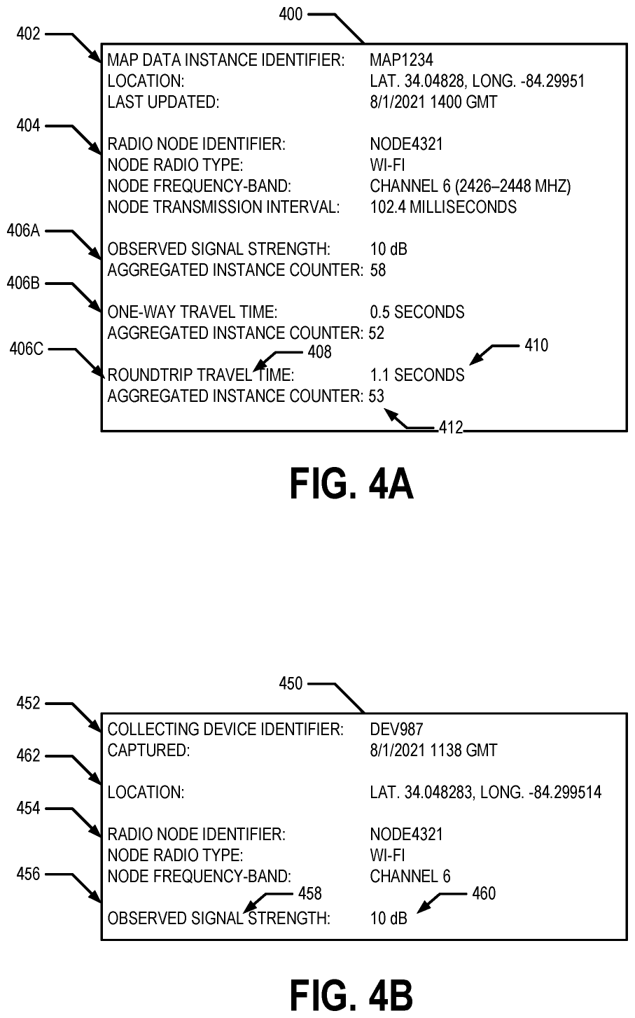

FIG. 4A illustrates an example map data record 400 comprising instances of map data 406 (e.g., 406A, 406B, 406C). The example map data record 400 is part of a radio map of the geographic database. The map data record 400 comprises record meta data 402 that includes a record identifier configured to identify the map data record, an indication of the location to which the map data record 400 corresponds (e.g., a position estimate approximating the position of collecting devices 20 when they observed a radio node 40 for which values of indicated observation types are provided), a timestamp indicating when the map data record 400 was last updated, and/or the like. In the illustrated embodiment, the map data record 400 comprises radio node information 404 that characterizes a radio node 40 observed at the indicated location. In an example embodiment, the radio node information 404 comprises a radio node identifier configured to identify the radio node 40, a radio type for the radio node 40 (e.g., Wi-Fi, Bluetooth, cellular, 5G, and/or the like), a transmission channel and/or frequency band at which the radio node 40 transmits signals, a radio node transmission interval (the time interval between the transmission of signals by the radio node 40), and/or the like.

The map data record 400 further comprises three instances of map data 406A, 406B, 406C. Each instance of map data 406 comprises an observation type indicator 408, a value 410 for the indicated observation type, and a counter 412 indicating the number and/or quantity of instances of contributed data that have been aggregated and/or integrated to generate and/or determine the value 410.

FIG. 4B illustrates an example instance of contributed data 450, according to an example embodiment. The instance of contributed data 450 comprises instance metadata 452. The instance metadata 452 comprises a collecting device identifier configured to identify the collecting device 20 that captured and/or generated the instance of contributed data 450 and/or to enable instances of contributed data captured by the same collecting device 20 to be identified, grouped, sequenced, and/or the like. In the illustrated embodiment, the instance metadata 452 further includes a timestamp indicating when the instance of contributed data 450 was captured and/or generated. The instance of contributed data 450 further includes an instance of location data 462 that indicates an observation location. The observation location is the location of the collecting device 20 when the collecting device 20 observed the radio node 40 as characterized by the instance of contributed data. In other words, the observation location indicates where collecting device was located when the collecting device 20 observed, received, measured, and/or the like the radio signal generated and/or transmitted by the radio node 40 with the value(s) provided by the instance of contributed data.

In an example embodiment, the instance of contributed data 450 comprises radio node information such as a radio node identifier configured to locally and/or globally identify the radio node 40 observed by the collecting device 20 at the observation location, a radio type for the radio node 40 (e.g., Wi-Fi, Bluetooth, cellular, 5G, and/or the like), a transmission channel and/or frequency band at which the radio node 40 transmits signals, a radio node transmission interval (the time interval between the transmission of signals by the radio node 40), and/or the like, as observed by the collecting device 20. The illustrated instance of contributed data 450 further includes the contributed data 456, which includes an observation type indicator 458 and a corresponding value 460. For example, the instance of contributed data 450 indicates that at the observation location indicated by the instance of location data 462, the collecting device 20 observed the radio node identified by the radio node information 454 with an observed signal strength of 10 dB.

In various embodiments, an instance of contributed data 450 of the group of instances of contributed data is aggregated and/or integrated into a relevant instance of existing map data 406 of a map data record 400. In various embodiments, for an instance of contributed data comprising an instance of location data indicating a first observation location and a value for a first observation type (e.g., observed signal strength observed one way travel time, observed roundtrip travel time, and/or the like in the scenario where the instance of contributed data comprises an instance of radio observation data), an instance of existing map data is relevant to the instance of contributed data when (a) the instance of existing map data indicates a particular location and the particular location, with respect to the first observation location, satisfies a distance criteria and/or (b) the instance of existing map data comprises a value for the first observation type. In various embodiments, another instance of contributed data is relevant to the instance of contributed data indicating the first observation location and a value for the first observation type when the instance of existing map data that is relevant to the instance of contributed data is relevant to the other instance of contributed data. In various embodiments, another instance of contributed data is relevant to the instance of contributed data indicating the first observation location and a value for the first observation type when a second observation location satisfies a distance criteria with respect to the first observation location and the other instance of contributed data indicates a value for the first observation type.

In an example embodiment, a particular location or a second observation location satisfies a distance criteria with respect to a first observation location when the particular location or the second observation location is within a set distance threshold of the first observation location. In various embodiments, the set distance threshold is a distance (e.g., Euclidean distance) for which various observations of the first observation type are not expected to change significantly. For example, if the first observation type is observed signal strength, two observations of the observed signal strength of a particular radio node 40 at locations separated by the set distance threshold are expected to not be significantly different (e.g., to agree within the known and/or expected possible error in the measurement, agree within another to within a set percentage (e.g., within 0.5%, 1%, 2%, 5%, and/or the like of one another, agree within significant digits, and/or the like). In various embodiments, the set distance threshold is dependent on the observation type.

In an example embodiment, a grid is defined over at least a portion of the geographic region corresponding to the geographic database is defined such that the geographic area is represented by a plurality of grid elements (e.g., squares, rectangles, and/or other tilings of the geographic region). In an example embodiment, the particular location or the second observation location satisfies the distance criteria with respect to the first observation location when the particular location or the second observation location is located within the same grid element as the first observation location.

In various embodiments, the instance of contributed data is aggregated and/or integrated with the relevant instance of existing map data and/or other relevant instances of contributed data to generate an instance of map data. For example, the value of the first observation type indicated by the instance of contributed data may be averaged (possibly in a weighted manner) with the corresponding value of the first observation type indicated by the relevant instance of existing map data and/or the respective values of the first observation type indicated by the relevant other instances of contributed data. Thus, a new or updated value of the first observation type is generated and/or determined and the geographic database (e.g., the corresponding map data record) is updated (or generated if not already existing) to indicate the new or updated value of the first observation type corresponding to the particular location.

Once the group of instances of contributed data is aggregated and/or integrated into the geographical database (e.g., respective instances are used to update and/or generate one or more instances of map data by combining or aggregating one or more observation values indicated by the respective instance of contributed data with observation values of other instances of contribution data and/or instances of existing map data) the network device 10 may delete the group of instances of contributed data. In other words, the network device 10 may not store (e.g., in memory 14) the group of instances of contributed data in its original form (e.g., as individual instances and/or a collection of instances of contributed data).

At some later point in time, the network device 10 detects a reversion trigger indicating the group of instances of contributed data that has already been aggregated and/or integrated into the geographic database, at block 312. For example, the network device 10 comprises means, such as processor 12, memory 14, communication interface 16, and/or the like, for detecting a reversion trigger indicating the group of instances of contributed data that has already been aggregated and/or integrated into geographic database. For example, a user of a collecting device 20 may determine that the collecting device 20 is not operating properly, that noticeable map or location errors are present, that imprecise manual position indication has been provided, that user guidance has been misunderstood, and/or other event and/or indication that an instance of contributed data and/or a batch or group of instances of contributed data may be potentially inaccurate. In response to determining that the instance of contributed data and/or batch or group of instances of contributed data may be potentially inaccurate, the user of the collecting device 20 may provide user input (e.g., via user interface 28) recalling an instance of contributed data and/or a batch or group of instances of contributed data. Responsive to receiving an indication of the user input, the collecting device 20 and/or the third-party device 30 may generate and provide a reversion trigger corresponding to and/or identifying the instance of contributed data and/or the batch(es) or group(s) of instances of contributed data that have been determined to be potentially inaccurate. In another example, a user or an application operating on a collecting device 20, third-party device 30, and/or network device 10 may determine that the digital map is of lower quality after the aggregation and/or integration of an instance of contributed data and/or a batch or group of instances of contributed data. For example, the positioning accuracy in the vicinity of the location(s) indicated by the instance(s) of location data of the instance of contributed data and/or batch(es) or group(s) of instances of contributed data may be reduced after the aggregation and/or integration of the instance of contributed data and/or batch(es) or group(s) of instances of contributed data into the map data of the geographical database compared to before the aggregation and/or integration of the instance of contributed data and/or batch(es) or group(s) of instances of contributed data into the map data of the geographical database. In various embodiments, an application operating on the collecting device 20 and/or third-party device 30 may determine, based on one or more criteria, that an instance of contributed data and/or a batch or group of instances of contributed data are potentially inaccurate. Responsive to such a determination, the respective collecting device 20, third-party device 30, and/or network device 10 may generate and/or provide a reversion trigger.

Responsive to receiving the reversion trigger (e.g., via user interaction with user interface 18 and/or via communication interface 16) and/or determining that an application operating on the network device 10 generated a reversion trigger, the network device 10 detects the reversion trigger.

At block 314, the network device 10 obtains a copy of the group of instances of contributed data indicated by the reversion trigger. For example, the network device 10 comprises means, such as processor 12, memory 14, communication interface 16, and/or the like, for obtaining a copy of the group of instances of contributed data indicated by the reversion trigger. In an example embodiment, the copy of the group of instances of contributed data indicated by the reversion trigger are provided along with and/or as part of the reversion trigger. In an example embodiment, the reversion trigger comprises sufficient information (e.g., a group identifier, capturing collecting device identifiers and timestamps or a time range, a pointer to where the indicated group of instances of contributed data are stored by the collecting device 20 and/or third-party device 30, an index usable to retrieve the group of instances of contributed data from a database, for example, stored by the collecting device 20 and/or third-party device 30, and/or the like) such that the network device 10 may generate and provide a request for a copy of the group of instances of contributed data indicated in the reversion trigger. For example, in an example embodiment, the network device 10 generates and provides (e.g., transmits) a request for a copy of the group of instances of contributed data indicated in the reversion trigger for receipt by the collecting device 20 or the third-party device 30. The collecting device 20 or the third-party device 30 then provides (e.g., transmits) a copy of the indicated group of instances of contributed data for receipt by the network device 10. The network device 10 then receives the copy of the group of instances of contributed data.

At block 316, the network device 10 may determine whether and/or confirm that a hash of the group of instances of contributed data is present in a hash registry (e.g., stored by memory 14). For example, the network device 10 may comprise means, such as processor 12, memory 14, and/or the like for determining whether and/or confirming that a hash of the group of instances of contributed data is present in the hash registry. For example, a hash for the copy of the group of instances of contributed data is determined using a selected hashing function. It may then be determined whether there is a hash in the hash registry that matches the hash determined for the copy of the group of instances of contributed data. For example, determining whether and/or confirming that a hash of the group of instances of contributed data is present in the hash registry may be used to confirm that the group of instances of contributed data were (likely) aggregated and/or integrated into the geographical database and the process continues to block 318. When it is determined that a hash of the group of instances of contributed data is not present in the hash registry, it is determined that the group of instances of contributed data was not aggregated and/or integrated into the geographical database and the process is terminated (possibly with the issuance and/or storing of a notification or alert via user interface 18 and/or memory 14, as appropriate).

At block 318, the network device 10 determines and/or generates at least one instance of reverted map data by de-aggregating the group of instances of contributed data from the geographical database of the digital map. For example, the network device 10 comprises means, such as processor 12, memory 14, and/or the like for determining and/or generating at least one instance of reverted map data by de-aggregating the group of instances of contributed data from the geographical database.

For example, for each instance of contributed data of the group of instances of contributed data, an instance of map data into which the instance of contributed data was aggregated and/or integrated is identified. For example, the instance of contribution data includes an instance of location data indicating an observation location and a value for an observation of a first observation type. A map data record and/or instances of map data that indicate a particular location that, with respect to the observation location, satisfies the distance criteria are identified.

From the map data record(s) and/or instance(s) of map data identified as satisfying the distance criteria with respect to the observation location, an instance of map data that includes a value and/or field for the first observation type (e.g., observed signal strength observed one way travel time, observed roundtrip travel time, and/or the like in the scenario where the instance of contributed data comprises an instance of radio observation data) is identified as the instance of map data into which the instance of contributed data was aggregated and/or integrated. The observed value of the first observation type indicated by the instance of contributed data may then be de-aggregated and/or de-integrated from the corresponding value of the first observation type indicated by the identified instance of map data. For example, the value of the first observation type indicated by the identified instance of map data may be an average and/or weighted average of the plurality of observation values (indicated by a respective plurality of instances of contributed data) and the observation value of the instance of contributed data may be de-aggregated and/or de-integrated (e.g., de-averaged and/or taken out of the average) from the value indicated by the identified instance of map data to generate a reverted value. For example, the value of the first observation type indicated by the identified instance of map data may be 10, the associated aggregated instance counter may be 20, and the observed value of the first observation type indicated by the instance of contributed data may be 16. By multiplying the value from the map data (e.g., 10) by the value of the aggregated instance counter (e.g., 20), subtracting the observed value (e.g., 16) therefrom, and dividing by the value of the decremented aggregated instance counter (e.g., 19) to arrive at the reverted value (e.g., 9.68), in an example embodiment.

The instance of reverted map data is then generated and/or determined by updating the identified instance of map data with the reverted value for the first observation type. As should be understood, the instance of map data may comprise values of second, third, etc. observation types which may be similarly updated with respective reverted values determined and/or generated by de-aggregating respective values of second, third, etc. observation types indicated by the instance of contribution data.

At block 320, the network device 10 stores and/or provides the at least one reverted instance of map data. For example, the network device 10 comprises means, such as processor 12, memory 14, communication interface 16, and/or the like, for storing and/or providing the at least one reverted instance of map data. For example, the network device 10 may provide (e.g., transmit) the at least one reverted instance of map data (e.g., as part of a map tile, map update, and/or the like) to one or more mobile devices, user devices, collecting devices 20, third-party devices 30, Cloud-based service, and/or the like. For example, the at least one reverted instance of map data may be stored and/or provided for use in performing one or more positioning and/or navigation-related functions. Some non-limiting examples of positioning and/or navigation-related functions include determining a position estimate, providing a route or information corresponding to a geographic area (e.g., via a user interface), localization, localization visualization, route determination, lane level route determination, operating a vehicle along at least a portion of a route, operating a vehicle along at least a portion of a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

At block 322, the network device 10 may cause the group of instances of contributed data to be deleted (e.g., from memory 14, 24, 34) and/or flagged (e.g., in memory 24, 34) to indicate that the corresponding group of instances of contributed data have been de-aggregated and/or de-integrated from the geographic database. For example, the network device 10 may comprise means, such as processor 12, memory 14, communication interface 16, and/or the like, for causing the group of instances of contributed data to be deleted (e.g., from memory 14, 24, 34) and/or flagged (e.g., in memory 24, 34) to indicate that the corresponding group of instances of contributed data have been de-aggregated and/or de-integrated from the geographic database. In an example embodiment, the network device 10 generates and provides (e.g., transmits) reversion instructions for receipt by the collecting device 20 and/or third-party device 30 that provided the copy of the group of instances of contributed data. The reversion instructions are configured such that when the collecting device 20 and/or third-party device 30 receives and processes the reversion instructions, the collecting device 20 and/or contribute device 30 is caused to delete the group of instances of contributed data from its memory 24, 34 and/or to flag the group of instances of contributed data in its memory 24, 34 to indicate that the corresponding group of instances of contributed data have been de-aggregated and/or de-integrated from the geographic database, in an example embodiment.

B. Example Operation of a Network Device to Aggregate and/or Integrate a Group of Instances of Contributed Data into a Geographic Database

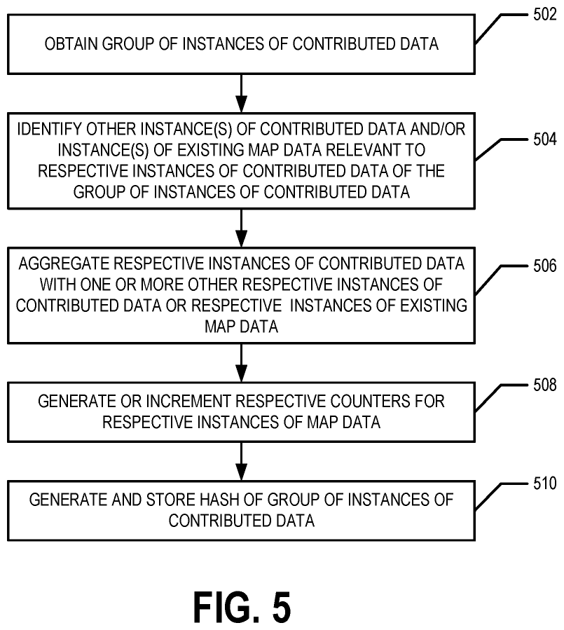

In various embodiments, a network device 10 receives an instance of contributed data and/or a group of instances of contributed data and aggregates and/or integrates the instance of contributed data and/or the group of instances of contributed data into the geographic database of the digital map. FIG. 5 provides a flowchart illustrating processes, procedures, operations, and/or the like, performed by a network device 10, for example, for aggregating a group of instances of contributed data into a geographical database. In an example embodiment, the processes, procedures, operations, and/or the like of FIG. 5 are performed as part block 302 of FIG. 3.

FIG. 5 is described herein using a group of instances of contributed data. As should be understood, the processes, procedures, operations and/or the like described with respect to FIG. 5 could be similarly performed on individual instances of contributed data.

Starting at block 502, the network device 10 obtains a group of instances of contributed data. For example, the network device 10 comprises means, such as processor 12, memory 14, communication interface 16, and/or the like, for obtaining a group of instances of contributed data. For example, the collecting device 20 and/or the third-party device 30 provides (e.g., transmits) a group of instances of contributed data such that the network device 10 receives the group of instances of contributed data. In an example embodiment, the network device 10 access the group of instances of contributed data from memory 14.

At block 504, the network device 10 identifies one or more other instances of contributed data (from the group of instances of contributed data or from a different group of contributed data) and/or an instance of existing map data that is relevant to a respective instance of contributed data of the group of instances of contributed data. For example, the network device 10 comprises means, such as processor 12, memory 14, and/or the like for identifying one or more other instances of contributed data and/or an instance of existing map data that is relevant to a respective instance of contributed data of the group of instances of contributed data. In an example embodiment, a respective one or more other instances of contributed data and/or a respective instance of existing map data that are relevant to each respective instance of contributed data of the group of instances contributed data. As described above, the relevant instance of existing map data and/or one or more relevant instances of contributed data are associated with a same location (e.g., satisfy distance criteria) of the instance of contribution data (e.g., as indicated by the corresponding instance of location data); correspond to a same observable item (e.g., radio node, feature, and/or the like); include a value or field for a same observation type (e.g., observed signal strength, observed one way travel time, and/or radio observed round trip travel time when the observation is of a radio node; observed color, observed reflectivity, observed height, etc. when the observation is of a visual feature; and/or the like), and/or the like.

At block 506, the network device 10 aggregate and/or integrates respective instances of contributed data with the respective relevant one or more instances of contributed data and/or instance of existing map data to generate and/or determine a respective instances of map data. For example, the network device 10 comprises means, such as processor 12, memory 14, and/or the like, for aggregating respective instances of contributed data with the respective relevant one or more instances of contributed data and/or instance of existing map data to generate and/or determine a respective instances of map data. For example, when the instance of contributed data includes an observed signal strength for a particular radio node 40 observed from an observation location, the relevant instance of existing map data includes an aggregated and/or integrated observed signal strength for the particular radio node 40 at a particular location that, with respect to the observation location, satisfies a distance criteria and/or the one or more relevant instances of contributed data include respective observed signal strengths for the particular radio node 40 observed from locations that satisfy the distance criteria with respect to the particular location and/or the observation location. The various observed signal strengths (e.g., the observed signal strengths of the instance of contributed data and the one or more other instances of relevant contributed data and/or the aggregated and/or integrated observed signal strength of the instance of existing map data) may be averaged, for example, to generate an instance of map data. As should be understood, the relevant instance of existing map data was generated by aggregating a plurality of instances of contributed data.

For example, a value of a first observation type indicated by the instance of contributed data of the group of instances of contributed data may be averaged (possibly in a weighted manner) with a corresponding value of the first observation type indicated by the relevant instance of existing map data and/or the respective values of the first observation type indicated by the relevant other instances of contributed data. Thus, a new or updated value of the first observation type is generated and/or determined and the relevant instance of existing map data is updated to form an instance of map data that indicates the new or updated value of the first observation type corresponding to the location and/or an instance of map data is generated that indicates the new or updated value of the first observation type corresponding to the location.

At block 508, the network device 10 generates and/or increments respective counters for respective instances of map data that were generated and/or updated based at least in part on the respective instances of contributed data of the group of instances of contributed data. For example, the network device 10 comprises means, such as processor 12, memory 14, and/or the like, for generating and/or incrementing respective counters for respective instances of map data that were generated and/or updated based at least in part on the respective instances of contributed data of the group of instances of contributed data. For example, if an instance of map data was generated and/or determined by aggregating an instance of contributed data from the group of instances of contributed data into an instance of existing map data, the counter for the resulting instance of map data have a value that is one greater than the counter for the instance of existing map data. In another example, if an instance of map data is aggregated and/or integrated with three other relevant instances of contributed data to generate a new instance of map data (e.g., such that four instances of contributed data are used to generate the new instance of map data), the corresponding counter is generated with a value of four. In various embodiments, the counter value corresponding to an instance of map data is stored in association with and/or as part of the instance of map data.

At block 510, the network device 10 generates and stores a hash of the group of instances of contributed data. For example, the network device 10 comprises means, such as processor 12, memory 14, and/or the like, for generating and storing a hash of the group of instances of contributed data. In various embodiments, the network device 10 stores a hash registry in memory 14 that includes respective hashes of groups of instances of contributed data that were aggregated and/or integrated into the geographical databases. In various embodiments, each of the hashes were generated with a selected hashing function. In an example embodiment, the selected hashing function is the same hashing function for each of the groups of instances of contributed data. In an example embodiment, the selected hashing function is selected from a group of hashing functions based on an attribute of the group of instances of contributed data (e.g., a number of instances of contributed data in the group, a geographical area where the instances of contributed data were captured, and/or the like). Once the network device 10 generates and stores the hash of the group of instances of contributed data, the network device 10 may remove (e.g., delete) the group of instances of contributed data from the memory 14.

C. Example Operation of a Network Device to De-aggregate and/or De-integrate a Group of Instances of Contributed Data from the Geographic Database

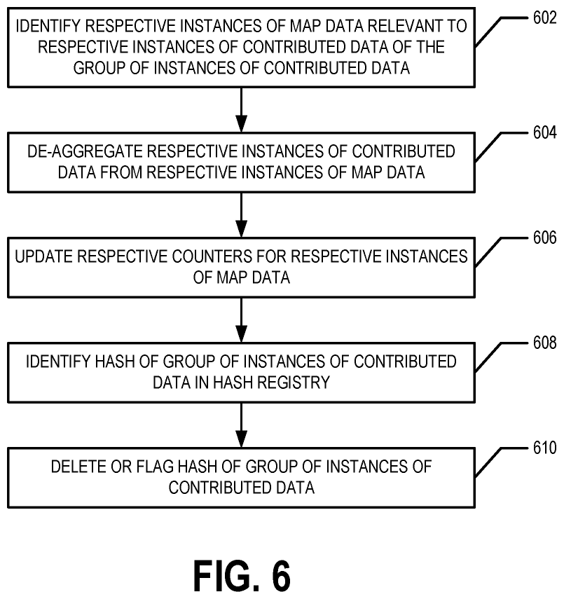

In various embodiments, a network device 10 detects a reversion trigger indicating a group of instances of contributed data and obtains a copy of the group of instances of contributed data. In various embodiments, the reversion trigger indicates that a potential inaccuracy in the referenced group of instances of contributed data has been identified and the referenced group of instances of contributed data should be de-aggregated and/or de-integrated from the geographical database of the digital map. FIG. 6 provides a flowchart illustrating processes, procedures, operations, and/or the like, performed by a network device 10, for example, for de-aggregating a group of instances of contributed data from a geographical database. In an example embodiment, the processes, procedures, operations, and/or the like of FIG. 6 are performed as part block 318 of FIG. 3.

FIG. 6 is described herein using a group of instances of contributed data. As should be understood, the processes, procedures, operations and/or the like described with respect to FIG. 6 could be similarly performed on individual instances of contributed data.

Starting at block 602, the network device 10 identifies respective instances of map data that are relevant to a respective instance of contributed data of the group of instances of contributed data. For example, the network device 10 comprises means, such as processor 12, memory 14, and/or the like for identifying respective instances of map data that are relevant to a respective instance of contributed data of the group of instances of contributed data. In an example embodiment, a respective one or more other instances of contributed data and/or a respective instance of contributed data that are relevant to each respective instance of contributed data of the group of instances contributed data. An instance of map data is relevant to an instance of contributed data when the instance of map data and the instance of contributed data are associated with a same location (e.g., satisfy distance criteria) of the instance of contribution data (e.g., as indicated by the corresponding instance of location data); correspond to a same observable item (e.g., radio node, feature, and/or the like); include a value or field for a same observation type (e.g., observed signal strength, observed one way travel time, and/or radio observed round trip travel time when the observation is of a radio node; observed color, observed reflectivity, observed height, etc. when the observation is of a visual feature; and/or the like), and/or the like.

At block 604, the network device 10 de-aggregates and/or de-integrates respective instances of contributed data of the group of instances of contributed data from the respective relevant instances of map data. For example, the network device 10 comprises means, such as processor 12, memory 14, and/or the like for de-aggregating respective instances of contributed data of the group of instances of contributed data from the respective relevant instances of map data. For example, in an example embodiment, the value of a counter associated with the relevant instance of map data is multiplied by the value for the corresponding observation type of the instance of map data to generate a product. The observed value from the instance of contributed data is subtracted from the product and the counter associated with the identified instance of map data is reduced (e.g., incremented down or decremented by 1) and the difference between the product and the observed value is divided by the value of the reduced counter to generate and/or determine a reverted value. The identified instance of map data is then updated with the reverted value to generate and/or determine an instance of reverted map data from which the instance of contributed data has been de-aggregated and/or de-integrated. For example, a value of the instance of map data is reverted to a reverted value that does not include and/or is not influenced by the observed value of the instance of contributed data.

At block 606, the network device 10 updates the respective counters of the respective instances of the reverted map data based on the de-aggregation and/or de-integration of the respective instances of contributed data from the respective instances of map data. For example, the network device 10 comprises means, such as processor 12, memory 14, and/or the like for updating the respective counters of the respective instances of the reverted map data based on the de-aggregation and/or de-integration of the respective instances of contributed data from the respective instances of map data. For example, the counter of an instance of map data from which a respective instance of contributed map data was de-aggregated and/or de-integrated is reduced and/or decremented by one and the reduced counter value is stored to and/or associated with the instance of reverted map data. For example, if an instance of map data was generated by aggregating fifty instances of contributed data the instance of map data is associated with and/or includes a counter with a value of fifty. When the instance of contributed data from the group of instances of contributed data is de-aggregated and/or de-integrated from the instance of map data, the counter is reduced to forty-nine such that the counter associated with the instance of reverted map data has a value of forty-nine to indicate that the reverted value of the instance of reverted map data was generated by the aggregation and/or integration of forty-nine instances of contributed data.

At block 608, the network device 10 identifies the hash of the group of instances of contributed data. For example, the network device 10 comprises means, such as processor 12, memory 14, and/or the like, for identifying the hash of the group of instances of contributed data. For example, a hash of the group of instances of contributed data is determined using a selected hashing function that was used to generate a hash of the group of instances of contributed data when the group of instances of contributed data were aggregated and/or integrated into the geographic database. For example, in an example embodiment where the selected hashing function used to generate a hash of the group of instances of contributed data is selected from a group of hashing functions based on an attribute of the group of instances of contributed data (e.g., a number of instances of contributed data in the group, a geographical area where the instances of contributed data were captured, and/or the like), the same hashing function is selected from the group of hashing functions as would have been previously selected. A hash stored in the hash registry that matches the hash determined for the group of instances of contributed data is identified.

At block 610, the network device 10 deletes or flags the identified hash. For example, the network device 10 comprises means, such as processor 12, memory 14, and/or the like, for deleting or flagging the identified hash. For example, the identified hash that matches the hash determined for the group of instances of contributed data is deleted from the hash registry, in an example embodiment. For example, the identified hash is flagged to indicate that the corresponding group of instances of contributed data have been de-aggregated and/or de-integrated from the geographic database, in an example embodiment.

D. Example Operation of a Collecting Device and/or Third-party Device

In various embodiments, one or more collecting devices 20 collect, generate, and/or capture instances of contributed data. The one or more collecting devices 20 and/or respectively associated third-party devices 30 provide the instances of contributed data (possibly in batches or groups) such that the network device 10 receives the instances of contributed data and aggregate and/or integrates them into the geographical database of the digital map. In various embodiments, a collecting device 20 and/or a third-party device 30 may determine and/or identify a potential inaccuracy in instances of contributed data (and/or a batch or group of instances of contributed data) that was already provided for aggregation and/or integration into the geographic database. Responsive to determining and/or identifying the potential inaccuracy in the instances of contributed data, the collecting device 20 and/or third-party device 30 generates and provides a reversion trigger such that the network device 10 receives the reversion trigger.

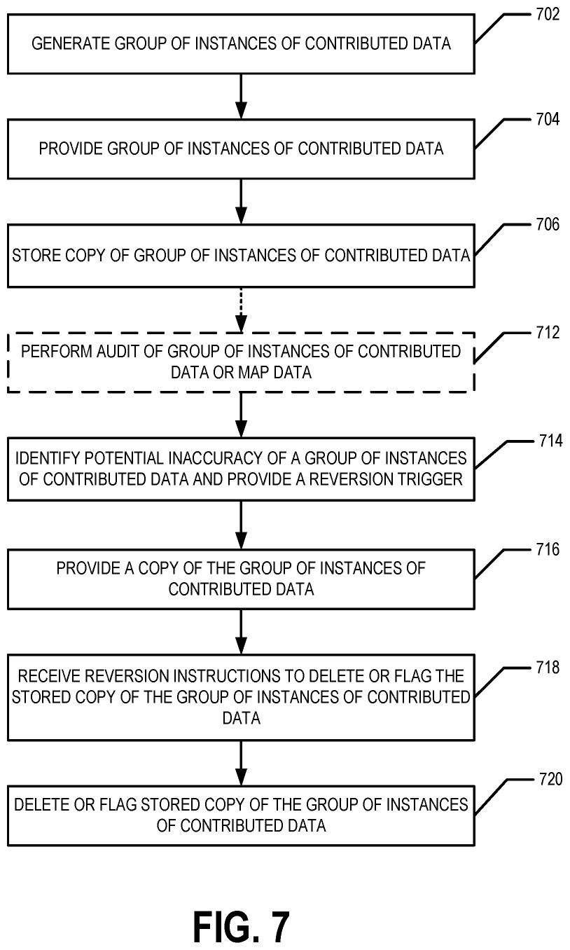

FIG. 7 provides a flowchart illustrating various processes, procedures, operations, and/or the like that are performed by a collecting device 20 and/or a third-party device 30, in various embodiments. Starting at block 702, a group of instances of contributed data is generated. For example, a collecting device 20 captures, generates, and/or collects a plurality of instances of contributed data. For example, the collecting device 20 comprises means, such as processor 22, memory 24, sensors 29, and/or the like for capturing, generating, and/or collecting a plurality of instances of contributed data. For example, the sensors 29 of the collecting device 20 may provide signals (e.g., to processor 22) that encode observations of one or more observable objects (e.g., radio signal measurements corresponding to an observed radio node 40, visual measurements of a visible feature, and/or the like). In an example embodiment, the collecting device 20 connects and/or associates a plurality of instances of contributed data into a group of instances of contributed data that are provided (e.g., transmitted) and/or stored (e.g., in memory 24, 34) as a batch or group.

In an example embodiment, the collecting device 20 provides the plurality of instances of contributed data (or a group of instances of contributed data) for receipt by the third-party device 30. In an example embodiment, the third-party device 30 receives a plurality of instances of contributed data captured, generated, and/or collected by one or more collecting devices 20. The third-party device 30 may form one or more groups of instances of contributed data from plurality of instances of contributed data. For example, the third-party device 30 comprises means, such as processor 32, memory 34, communication interface 36, and/or the like, for generating a group of instances of contributed data.

At block 704, the collecting device 20 and/or third-party device 30 provides the group of instances of contributed data for receipt by the network device 10. For example, the collecting device 20 and/or third-party device 30 comprises means, such as processor 22, 32, memory 24, 34, communication interface 26, 36, and/or the like, for providing the group of instances of contributed data such that the network device 10 receives the group of instances of contributed data.

At block 706, the collecting device 20 and/or third-party device 30 stores a copy of the group of instances of contributed data. For example, the collecting device 20 and/or third-party device 30 comprises means, such as processor 22, 32, memory 24, 34, and/or the like, for storing a copy of the group of instances of contributed data. For example, a provided data database may be stored in memory 24, 34 in which are stored respective copies of the groups of instances of contributed data that the collecting device 20 and/or third-party device 30 has provided for receipt by the network device 10.

At some later point in time, at block 712, a collecting device 20 and/or third-party device 30 may perform an audit of a group of instances of contributed data and/or map data. For example, the collecting device 20 and/or third-party device 30 may comprise means, such as processor 22, 32, memory 24, 34, and/or the like, for performing an audit of a group of instances of contributed data and/or map data. For example, the audit may include measuring and/or evaluating the accuracy of various instances of contributed data of the group of instances of contributed data. For example, the audit may include comparing the accuracy of the map data before the group of instances of contributed data were aggregated and/or integrated into the map data and after the group of instances of contributed data were aggregated and/or integrated into the map data.

At block 714, a collecting device 20 and/or third-party device 30 generates and provides a reversion trigger. For example, the collecting device 20 and/or third-party device 30 comprises means, such as processor 22, 32, memory 24, 34, communication interface 26, 36, user interface 28, 38, and/or the like, for generating and providing a reversion trigger. For example, based on the audit of the group of instances of contributed data, a potential inaccuracy of the group of instances of data is identified. For example, user input may be received (e.g., via user interface 28, 38) indicating an identified potential inaccuracy of the group of instances of contributed data. In another example, an application operating on the collecting device and/or third-party device 30 identifies a potential inaccuracy of the group of instances of contributed data. Based on the identified potential inaccuracy of the group of instances of contributed data and/or responsive to identifying the potential inaccuracy of the group of instances of contributed data, the collecting device 20 and/or the third-party device 30 generates and provides a reversion trigger. For example, the network device 10 receives a reversion trigger generated and provided by the collecting device 20 and/or third-party device 30. In various embodiments, the reversion trigger indicates the group of instances of contributed data for which the potential inaccuracy was identified.

At block 716, the collecting device 20 and/or the third-party device 30 accesses (e.g., from memory 24, 34) and provides (e.g., transmits) a copy of the group of instances of contributed data indicated by the reversion trigger. For example, the collecting device 20 and/or third-party device 30 comprises means, such as processor 22, 32, memory 24, 34, communication interface 26, 36, and/or the like, for accessing and providing the copy of the group of instances of contributed data indicated by the reversion trigger. For example, the network device 10 receives the copy of the group of instances of contributed data indicated by the reversion trigger. In an example embodiment, the copy of the group of instances of contributed data are provided with the reversion trigger. In an example embodiment, the copy of the group of instances of contributed data are accessed and provided in response to receiving a request for the copy of the group of instances of contributed data.

After the network device 10 processes the reversion trigger, based at last in part on the copy of the group of instances of contributed data, the network device 10 generates and provides reversion instructions, in various embodiments. At block 718, the collecting device 20 and/or third-party device 30 receives the reversion instructions. For example, the collecting device 20 and/or third-party device 30 comprises means, such as processor 22, 32, memory 24, 34, communication interface 26, 36, and/or the like, for receiving the reversion instructions.

At block 720, the collecting device 20 and/or third-party device 30 processes and/or executes the reversion instructions. For example, the collecting device 20 and/or third-party device 30 comprises means, such as processor 22, 32, memory 24, 34, and/or the like, for processing and/or executing the reversion instructions. Processing and/or executing the reversion instructions causes the collecting device 20 and/or third-party device 30 to delete the copy of the group of instances of contributed data from memory 24, 34, in various embodiments. In an example embodiment, processing and/or executing the reversion instructions causes the collecting device 20 and/or third-party device 30 to flag the copy of the group of instances of contributed data in memory 24, 34 to indicate that group of instances of contributed data had been de-aggregated from the geographic database of the digital map.

### IV. Technical Advantages

Technical problems exist regarding how to remove any instances of contributed data that have been identified as potentially inaccurate from a geographic database into which the instances of contributed data have been aggregated and/or integrated. Various embodiments provide technical solutions to these technical problems, which enables the improved accuracy of map data of the geographic database.

For example, in an example embodiment, a reversion trigger corresponding to an instance of contributed data or a group of instances of contributed data is received, thereby indicating that the instance of contributed data or the group of instances of contributed data are potentially inaccurate and/or are otherwise being recalled. In various embodiments, a copy of the instance of contributed data and/or group of instances of contributed data are obtained. For example, the reversion trigger may include a copy of the instance of contributed data and/or group of instances of contributed data, a pointer, instance or group identifier, and/or index that may be used to access and/or request a copy of the instance of contributed data and/or group of instances of contributed data, and/or the like. One or more respective instances of map data that are relevant to the instance of contributed data and/or the group of instances of contributed data being recalled are identified. Based on the copy of the respective instance of contributed data and the respective instance of map data, a respective instance of reverted map data is generated by de-aggregating and/or de-integrating the respective instance of contributed data from the respective instance of map data. The respective instance of reverted map data is stored and/or provided, for example, for use in performing a positioning and/or navigation-related function. As various embodiments enable the potentially inaccurate instances of contributed data to be removed from the geographic database, various embodiments provide for a more accurate geographic database.

Additionally, various embodiments provide safe guards against bad faith actors taking advantage of the enabled ability to remove instances of contributed data from the geographic database to sabotage the accuracy and/or coverage of the geographic database. For example, in various embodiments, prior to generating the instance(s) of reverted map data, the network device may confirm that instance of contributed data and/or group of instances of contributed data indicated by the reversion trigger were used to update the geographic database and/or have not already be removed from the geographic database. For example, by checking that the hash of the instance of contributed data and/or group of instances of contributed data indicated by the reversion trigger is present in the hash registry (and not flagged as already having been de-aggregated and/or de-integrated) the network device may safeguard against bad faith actions. For example, in various embodiments, the hash corresponding to the instance of contributed data and/or group of instances of contributed data is deleted and/or flagged to indicate that the corresponding instance(s) of contributed data have been de-aggregated and/or de-integrated from the geographic database. In an example embodiment, the copy of the instance of contributed data and/or group of instances of contributed data is caused to be deleted and/or flagged to indicate that the corresponding instance(s) of contributed data have been de-aggregated and/or de-integrated from the geographic database.

Moreover, various embodiments enable contributing entities to have more control over the information/data contributed by the contributing entity (e.g., by agents of and/or computing devices operated by and/or on behalf of the contributing entity). For example, a contributing entity may cause generation and/or provision of a reversion trigger that causes and/or initiates the de-aggregation and/or de-integration of instances of contributed data that are identified as potentially inaccurate. Furthermore, such improvement is provided without requiring the network device to store and/or manage contributing entity data (e.g., other than perhaps a list of contributing entities, and/or the like). For example, in various embodiments, the network device need not store information regarding which contributing entities provided which instances of contributed data, the instances of contributed data, information regarding the collecting device that generated an instance of contributed data, and/or the like.

Thus, various embodiments provide improvements to the field of generating, updating, and/or maintaining a geographic database. For example, various embodiments provide improvements to the field of using crowd-sourced data to generate, update, and/or maintain a geographic database.

### V. Example Apparatus

The network device 10, collecting device 20, and/or third-party device 30 of an example embodiment may be embodied by or associated with a variety of computing devices including, for example, a navigation system including a global navigation satellite system (GNSS), a cellular telephone, a mobile phone, a smartphone, a personal digital assistant (PDA), a watch, a camera, a computer, an Internet of things (IoT) item, and/or other device that can observe the radio environment (e.g., receive radio frequency signals from network access points), physical environment, and/or other environment in the vicinity of the computing device and/or that can store, generate, update, and/or maintain at least a portion of a geographic database (e.g., digital map). Additionally or alternatively, the network device 10, collecting device 20, and/or third-party device 30 may be embodied in other types of computing devices, such as a server, a personal computer, a computer workstation, a laptop computer, a plurality of networked computing devices or the like, that are configured to generate, update, maintain, and/or store a geographic database (e.g., a digital map), and/or the like. In an example embodiment, a collecting device 20 is a smartphone, tablet, laptop, PDA, and/or other mobile computing device and a network device 10 and/or third-party device 30 is a server that may be part of a Cloud-based computing asset and/or processing system.

In some embodiments, the processor 12, 22, 32 (and/or co-processors or any other processing circuitry assisting or otherwise associated with the processor) may be in communication with the memory device 14, 24, 34 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the network device 10, collecting device 20, and/or third-party device 30 may be embodied by a computing entity and/or device. However, in some embodiments, the network device 10, collecting device 20, and/or third-party device 30 may be embodied as a chip or chip set. In other words, the network device 10, collecting device 20, and/or third-party device 30 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22, 32 may be embodied in a number of different ways. For example, the processor 12, 22, 32 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22, 32 may include one or more processing cores configured to perform independently. A multi-core processor may enable multiprocessing within a single physical package. Additionally or alternatively, the processor 12, 22, 32 may include one or more processors configured in tandem via the bus to enable independent execution of instructions, pipelining and/or multithreading.

In an example embodiment, the processor 12, 22, 32 may be configured to execute instructions stored in the memory device 14, 24, 34 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the network device 10, collecting device 20, and/or third-party device 30 may include a user interface 18, 28, 38 that may, in turn, be in communication with the processor 12, 22, 32 to provide output to the user, such as one or more navigable routes to a destination location and/or from an origin location, display of location dependent and/or triggered information, and/or the like, and, in some embodiments, to receive an indication of a user input. As such, the user interface 18, 28, 38 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22, 32 (e.g., memory device 14, 24, 34 and/or the like).

The network device 10, collecting device 20, and/or third-party device 30 may optionally include a communication interface 16, 26, 36. The communication interface 16, 26, 36 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, a network device 10, collecting device 20, and/or third-party device 30 may comprise a component (e.g., memory 14, 24, 34, and/or another component) that stores a digital map (e.g., in the form of a geographic database) comprising a plurality of map data records. In an example embodiment, the map data records comprising a first plurality of traversable map element (TME) data records each of the first plurality of TME data records representing a corresponding traversable map element. At least some of said first plurality of TME data records include map information/data indicate current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location, a radio-based position estimate) to a point on a map, a lane of a lane network, and/or link, one or more localization features and a corresponding location of each localization feature, and/or the like. For example, the geographic database may comprise a positioning map comprising a radio node registry and/or instances of map data records comprising information regarding the location and/or coverage areas of various radio nodes. For example, a geographic database may include road segment, segment, link, lane segment, or TME data records, point of interest (POI) data records, localization feature data records, and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the network device 10 may be configured to modify, update, and/or the like one or more map data records of the geographic database. For example, the network device 10 may modify, update, generate, and/or the like map information/data corresponding to the location and/or coverage areas of one or more radio nodes, the location and/or characteristics of one or more observable features, TMEs, links, lanes, road segments, travel lanes of road segments, nodes, intersection, pedestrian walkways, elevators, staircases, and/or the like and/or the corresponding map data records (e.g., to add or update updated map information/data including, for example, current traffic conditions along a corresponding TME; assign and/or associate an access point with a TME, lateral side of a TME, and/or representation of a building; and/or the like), a localization layer (e.g., comprising localization features), a registry of radio nodes to identify network access points and/or mobile access points, and/or the corresponding data records, and/or the like.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network and/or other traversable network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

### VI. Apparatus, Methods, and Computer Program Products

As described above, FIGS. 3, 5, 6, and 7 illustrate flowcharts of a network device 10, collecting device 20, and/or third-party device 30, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24, 34 of an apparatus employing an embodiment of the present invention and executed by the processor 12, 22, 32 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
after at least one instance of map data of a digital map has been generated or updated by aggregating at least a portion of an instance of contributed data with at least portions of one or more other instances of contributed data, detecting, by one or more processors, a reversion trigger corresponding to the instance of contributed data;
obtaining, by the one or more processors, a copy of the instance of contributed data;
based on at least a portion of the copy of the instance of contributed data and the at least one instance of map data, determining, by the one or more processors, at least one instance of reverted map data, wherein the at least one instance of reverted map data comprises values corresponding to a de-aggregation of the instance of contributed data from the at least one instance of map data; and
causing, by the one or more processors, at least one of storing or providing of the at least one instance of reverted map data as part of the digital map.

2. The method of claim 1, wherein the at least one instance of map data is associated with an instance counter indicating the number of instances of contributed data that have been aggregated to generate the at least one instance of map data and generating the at least one instance of reverted map data comprises decrementing the instance counter associated with the at least one instance of map data to determine a value of the instance counter associated with the at least one instance of reverted map data.

3. The method of claim 2, wherein de-aggregation of the instance of contributed data from the at least one instance of map data comprises determining a value sum based on the instance of map data and the instance counter associated with the instance of map data, subtracting an observation value of the instance of contributed data from the value sum to generate a reverted value sum, and determining a reverted value for the at least one instance of reverted map data based on the reverted value sum and the instance counter associated with the at least one instance of reverted map data.

4. The method of claim 1, wherein the digital map is configured for use in performing one or more positioning and/or navigation-related functions.

5. The method of claim 1, wherein the copy of the instance of contributed data is stored by a computing entity associated with an entity that contributed the instance of contributed data.

6. The method of claim 5, further comprising causing the copy of the instance of contributed data stored by the computing entity to be at least one of (a) deleted from memory of the computing entity or (b) flagged as having been de-aggregated from the digital map.

7. The method of claim 1, wherein the reversion trigger indicates that a potential inaccuracy of the at least one instance of contributed data has been detected.

8. The method of claim 1, wherein the reversion trigger is detected by a computing entity associated with an entity that contributed the instance of contributed data responsive to at least one of (a) receiving user input initiating the reversion trigger or (b) a reversion trigger initiation generated by an application operating on the computing entity.

9. The method of claim 1, wherein the reversion trigger is identified responsive to determining that a quality index corresponding to the instance of map data indicates that the instance of map data is of lower quality after the instance of map data was updated based on the instance of contributed data than before the instance of map data was updated based on the instance of contributed data.

10. The method of claim 1, wherein updating the at least one instance of map data based on the instance of contributed data comprises generating and storing a hash of the instance of contributed data in a hash registry, the method further comprising at least one of (a) deleting the hash of the instance of contributed data from the hash registry or (b) flagging the hash of the instance of contributed data in the hash registry to indicate that the instance of contributed data has been de-aggregated from the digital map.

11. The method of claim 1, wherein the at least one instance of contributed data is part of a group of instances of contributed data comprising a plurality of instances of contributed data, obtaining a copy of the at least one instance of contributed data comprises obtaining a copy of each of respective instance of contributed data of the plurality of instances of contributed data, determining at least one instance of reverted map data comprises determining one or more instances of reverted map data corresponding to respective ones of the plurality of instances of contributed data.

12. The method of claim 11, wherein updating the at least one instance of map data based on the plurality of instances of contributed data comprises generating and storing a hash of the plurality of instances of contributed data in a hash registry, the method further comprising at least one of (a) deleting the hash of the plurality of instances of contributed data from the hash registry or (b) flagging the hash of the plurality of instances of contributed data in the hash registry to indicate that respective instances of contributed data of the plurality of instances of contributed data have been de-aggregated from the digital map.

13. The method of claim 1, wherein the instance of contributed data comprises an instance of radio observation data comprising information characterizing an observation of a radio node by a collecting device and an instance of location data indicating the location of the collecting device when the radio node was observed.

14. The method of claim 13, wherein the information characterizing the observation of the radio node by the collecting device comprises at least one of (a) a radio node identifier, (b) an observed signal strength, or (c) an observed time parameter.

15. An apparatus comprising at least one processor and at least one memory storing computer program instructions, the at least one memory and the computer program code are configured to, with the processor, cause the apparatus to at least:
after at least one instance of map data of a digital map has been generated or updated by aggregating at least a portion of an instance of contributed data with at least portions of one or more other instances of contributed data, detect a reversion trigger corresponding to the instance of contributed data;
obtain a copy of the instance of contributed data;
based on at least a portion of the copy of the instance of contributed data and the at least one instance of map data, determine at least one instance of reverted map data, wherein the at least one instance of reverted map data comprises values corresponding to a de-aggregation of the instance of contributed data from the at least one instance of map data; and
at least one of store or provide the at least one instance of reverted map data as part of the digital map.

16. The apparatus of claim 15, wherein the at least one instance of map data is associated with an instance counter indicating the number of instances of contributed data that have been aggregated to generate the at least one instance of map data and generating the at least one instance of reverted map data comprises decrementing the instance counter associated with the at least one instance of map data to determine a value of the instance counter associated with the at least one instance of reverted map data.

17. The apparatus of claim 15, wherein the at least one instance of contributed data is part of a group of instances of contributed data comprising a plurality of instances of contributed data, obtaining a copy of the at least one instance of contributed data comprises obtaining a copy of each of respective instance of contributed data of the plurality of instances of contributed data, determining at least one instance of reverted map data comprises determining one or more instances of reverted map data corresponding to respective ones of the plurality of instances of contributed data.

18. The apparatus of claim 17, wherein updating the at least one instance of map data based on the plurality of instances of contributed data comprises generating and storing a hash of the plurality of instances of contributed data in a hash registry, the method further comprising at least one of (a) deleting the hash of the plurality of instances of contributed data from the hash registry or (b) flagging the hash of the plurality of instances of contributed data in the hash registry to indicate that respective instances of contributed data of the plurality of instances of contributed data have been de-aggregated from the digital map.

19. The apparatus of claim 15, wherein the instance of contributed data comprises an instance of radio observation data comprising information characterizing an observation of a radio node by a collecting device and an instance of location data indicating the location of the collecting device when the radio node was observed.

20. A method comprising:
storing, in a computer-readable memory, one or more instances of contributed data, wherein the one or more instances of contributed data have been provided for receipt by a network device for aggregation into at least one instance of map data of a geographic database;
accessing, by one or more processors, the one or more instances of contributed data;
causing, by the one or more processors, the one or more instances of contributed data to be provided for receipt by a network device;
receiving, by the one or more processors, at least one instance of reverted map data, wherein the at least one instance of reverted map data was determined by de-aggregating at least one of the one or more instances of contributed data from the at least one instance of map data; and
at least one of (a) causing the at least one instance of reverted map data to be stored in the computer-readable memory, or (b) using the at least one instance of reverted map data to perform at least one positioning and/or navigation-related function.
